(19) United States
(12) Patent Application Publication
(10) Pub. No.: US 2020/0364681 A1
(43) Pub. Date: Nov. 19, 2020

(54) LAUNDRY CHARGING SYSTEM

(71) Applicant: HAPPY CO., LTD., Uji-shi (JP)

(72) Inventor: Hideo HASHIMOTO, Uji-shi (JP)

(73) Assignee: HAPPY CO., LTD.

(21) Appl. No.: 16/870,342

(22) Filed: May 8, 2020

(30) Foreign Application Priority Data
May 17, 2019 (JP) 2019-093400

(51) Int. Cl. G06Q 20/08; G06Q 30/00; G06Q 20/42; G06Q 10/06; G06Q 10/10; G06K 7/10; D06F 33/47; D06F 34/04; D06F 93/00

(52) U.S. Cl. CPC G06Q 20/085; G06Q 30/0185; G06Q 20/42; G06Q 10/0635; H04L 51/18; G06K 7/10366; D06F 33/47; D06F 34/04; D06F 93/00; G06Q 10/10

(57) ABSTRACT

A laundry charging system manages a laundry article and does laundry based on an article number. The article number is contained in a tag attached to the laundry article. The head office is connected to a plurality of sites via network. The system has an issuer in the head office to generate the article number, a database in the head office to store a laundry record that includes information related to the laundry article corresponding to the article number, an access identifying unit in the head office to evaluate a type of access to the head office from the site, and a charging unit in the head office. When the access identifying unit identifies an access to the head office from the site that requests to the issuer for issuing the article number, the charging unit charges the site that is an access source.

### CROSS-REFERENCE TO RELATED APPLICATIONS

This application is claims priority to Japanese Application No. 2019-093400, filed on May 17, 2019. The entire disclosure of Japanese Application No. 2019-093400 is hereby incorporated herein by reference.

### BACKGROUND

### Technical Field

The present disclosure relates to a charging system in which a franchiser charges franchising fee to a franchisee, wherein the franchiser offers franchisees service framework necessary for configuring laundry service, and franchisees use service framework to provide customers with the laundry service.

### Background Information

A single business owner generally cannot offer the laundry service over a wide area because a lot of laundry shops, laundry plants and others are necessary to be placed in a large area. Applying franchising manner is one of methods to provide the service widely. For example, Japanese Laid-Open Patent Application Publication No. 2005-071112 and Japanese Laid-Open Patent Application Publication No. 2019-028579 disclose laundry services in a franchise manner. A franchiser typically offers franchisees service framework necessary for franchisees to provide customers with the laundry service.

### SUMMARY

In franchising applied to the laundry service, a franchiser establishes framework for operating laundry business to allow franchisees to use it and to provide with the laundry service. The charging system that a franchiser charges the franchisee a constant amount of fee or a portion of franchisee's profit is commonly adopted.

From the franchisee's viewpoint, fee is not proportionally linked to the number of franchisee's uses of the service framework established by a franchiser. Franchisees typically pay a fee, such as constant rated fee of franchisee's sales or a constant amount of fee, to a franchiser.

The laundry charging system of this disclosure was conceived to solve the above problem and provides a laundry charging method and a system therewith. The proposed method is that the charged fee is proportional to the number of franchisee's uses of the service framework established by a franchiser. The proposed system is based on the proposed method.

According to a first aspect of the present disclosure, a laundry charging system is provided for managing a laundry article and doing laundry based on an article number, the article number generated at a head office is contained in a tag, the tag is attached to the laundry article, the head office is connected to a plurality of sites via network, the system comprising an article number issuer in the head office to generate the article number, a database in the head office to store a laundry record that includes information related to the laundry article corresponding to the article number, an access identifying unit in the head office to evaluate a type of access to the head office from the site, and a charging unit in the head office, wherein, when the access identifying unit identifies an access to the head office from the site that requests to the article number issuer for issuing the article number, the charging unit charges the site.

According to a second aspect of the present disclosure, a laundry charging system is provided for managing a laundry article and doing laundry based on an article number, the article number generated at a head office is contained in a tag, the tag is attached to the laundry article, the head office is connected to a plurality of sites via network, the system comprising an article number issuer in the head office to generate the article number, a database in the head office configured to store a laundry record that includes information related to the laundry article corresponding to the article number, an access identifying unit in the head office configured to evaluate a type of access to the head office from the site, and a charging unit in the head office, wherein, when the access identifying unit identifies an access to the head office from the site that is the access bound for the laundry record based on the article number, the charging unit charges the site.

According to a third aspect of the present disclosure, the laundry charging system according to either the first or second aspect further comprises a tag reader in the site configured to read the tag, wherein the tag reader obtains the article number contained in the tag attached to the laundry article.

According to a fourth aspect of the present disclosure, the laundry charging system according to either the first or second aspect is configured so that in the case that the tag reader fails to obtain the article number from the tag, the site requests the head office to generate a new article number.

According to a fifth aspect of the present disclosure, the laundry charging system according to any one of the first to fourth aspects further comprises a module controller in the site configured to send the laundry record, which is sent from the head office, to a customer's terminal according to customer's contact information, wherein the laundry record includes the information, to send article's laundry information and article's risk information, both of which are sent from the head office, to the customer's terminal according to the customer's contact information, and to receive a first consent information from the customer's terminal, wherein the first consent information indicates that the customer consents to the updated laundry record and the article's laundry information, a process decision table in the head office configured to decide the article's laundry information related to the laundry article based on the laundry record, and a risk decision table in the head office configured to decide the article's risk information related to the laundry article based on the laundry record.

According to a sixth aspect of the present disclosure, the laundry charging system according to the fifth aspect further comprises the module controller configured to send a message to the customer's terminal according to the customer's contact information, wherein the message indicates a disorder is detected during washing process, and to receive second consent information from the customer's terminal, wherein the second consent information indicates customer's consent or dissent to continuing the washing process when the customer's terminal receives the message, wherein, in the case that the module controller receives the first and second consent information from the customer's terminal, the module controller reports completion of the washing process to the head office after finishing the predetermined process.

According to a seventh aspect of the present disclosure, the laundry charging system according to the first or second aspect is configured so that the laundry record includes images before and after the washing process, the customer's terminal has a display for displaying the images obtained through the head office based on the article number.

According to an eighth aspect of the present disclosure, the laundry charging system according to the seventh aspect is configured so that the images further include images recorded when the disorder is detected during the washing process.

According to a ninth aspect of the present disclosure, a laundry charging system comprises a network, an access identifying unit, and a charging unit. The network connects a head office and at least one site providing laundry service. The access identifying unit is configured to extract an access source identifier and an access destination identifier from an access signal that is a flow of an access coming from the site to the head office via the network, to store a predetermined first identifier, to compare the access destination identifier and the first identifier, and to output the access source identifier if the access destination identifier and the first identifier are the same value. The charging unit is configured to store a predetermined second identifier, to compare the outputted access source identifier and the second identifier, to count number of times that the outputted access source identifier and the second identifier are the same value, and to calculate fee to be charged to the site based on the number of times and a predetermined unit fee.

With the above described laundry charging system according to any one of the first to fourth aspects, the head office charges each site in the case that the site requests the head office to generate an article number necessary for the site to create a new laundry record, which allows the head office to charge each site in proportion to the site's requests for issuing article number.

In the above described laundry charging system, the head office acts a franchiser. A plurality of sites and customer's terminals act like franchisees. The head office charges each site every time the site requests the head office to generate an article number that is an index number to search for a laundry record. In other words, the franchiser charges each franchisee for fee as a use of framework for laundry service every time the franchisee requests an index number for a laundry record.

With the above described laundry charging system according to either the second or third aspect, the head office can charge each site in proportion to the site's requests for browsing laundry record. The head office charges each site every time the site requests for browsing laundry record, which is a part of the service framework. This makes usage fees of the laundry framework to be proportional to the number of franchisee's uses of laundry records.

Moreover, the head office can charge each customer in proportion to the number of the customer's accesses to laundry records.

With the above described laundry charging system according to the fifth aspect, the site's execution of the washing process follows the site's receipt of the first consent information about the article's laundry information and the article's risk information.

With the above described laundry charging system according to the sixth aspect, an occurrence of disorder during the washing process causes the site to report completion of the washing process only in the case of the site's receipt of not only the first consent information but also the second consent information from the customer's terminal, so as to reliably execute abnormal process in the occurrence of disorder.

With the above described laundry charging system according to either the seventh or eighth, inclusion of image in a laundry record allows the customer's terminal to easily search the laundry records for the image corresponding to a laundry article.

### BRIEF DESCRIPTION OF THE DRAWINGS

Referring now to the drawings which form part of this original disclosure:

FIG. 1 is a graph of an entire system of according to one embodiment;

FIG. 2 is a block diagram of the entire system of one embodiment illustrated by the functional module;

FIG. 3 is a block diagram of a central control module 30;

FIG. 4 is a block diagram of a control unit 51;

FIG. 5 is a block diagram of maximum configuration of a processing module;

FIG. 6 shows a chart of combination of devices used in a processing module;

FIG. 7 is a diagram of an example of connection between a head office and sites;

FIG. 8 is a diagram of another example of connection between a head office and sites;

FIG. 9 is a structure of a laundry record in laundry DB 60;

FIG. 10 is a structure of images in image DB 61;

FIG. 11 is a structure of a process management table;

FIG. 12 is an entire flowchart of laundry service described in according to one embodiment;

FIG. 13 is a flowchart of reception process in the entire flowchart of the laundry service;

FIG. 14 is a flowchart of recording process in the entire flowchart of the laundry service;

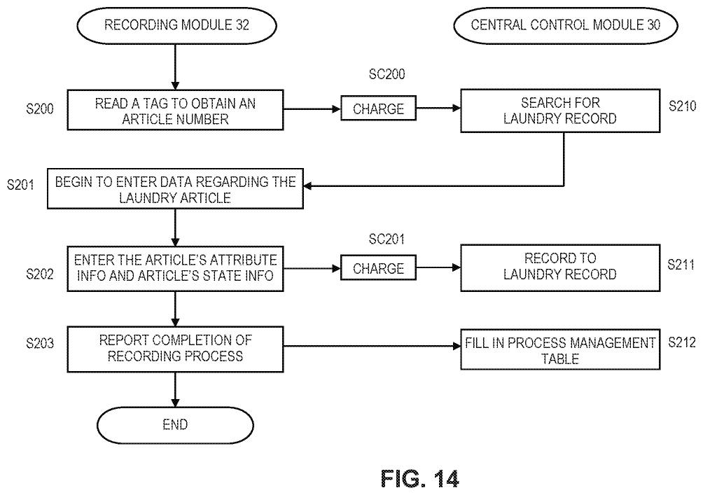

FIG. 15 is a flowchart of counselling process in the entire flowchart of the laundry service;

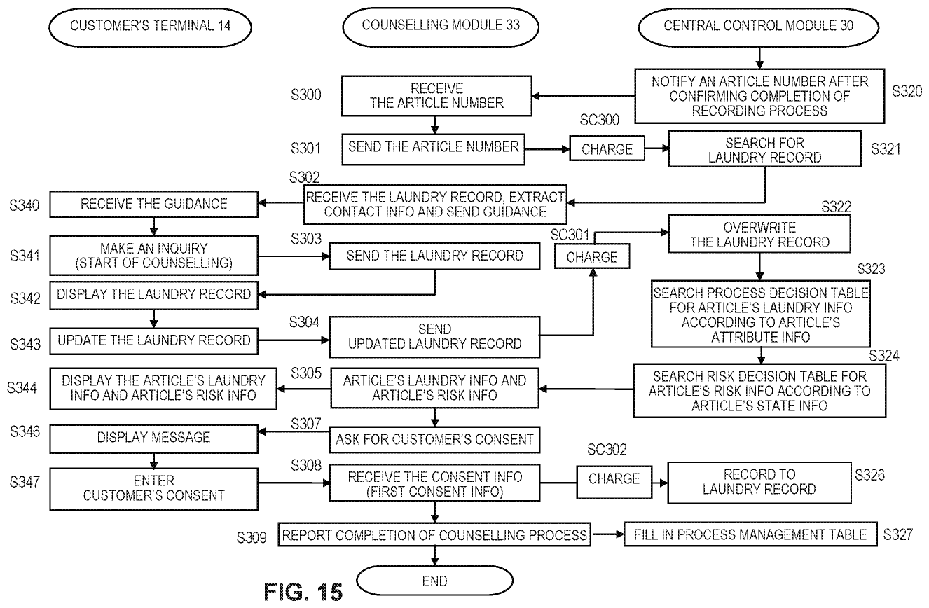

FIG. 16 is a flowchart of payment process in the entire flowchart of the laundry service;

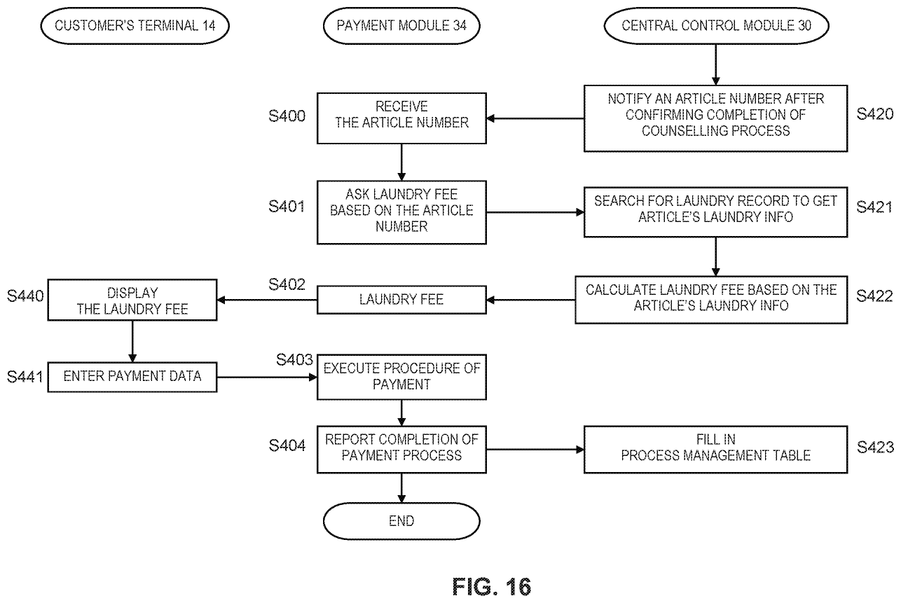

FIG. 17 is a flowchart of measuring process in the entire flowchart of the laundry service;

FIG. 18 is a flowchart of washing process in the entire flowchart of the laundry service;

FIG. 19 is a flowchart of shipping process in the entire flowchart of the laundry service;

FIG. 20 is a flowchart of storing process in the entire flowchart of the laundry service;

FIG. 21 is a flowchart of abnormal process in the flowchart of the washing process;

FIG. 22 is a graph of the entire system incorporating a garment factory and a clothing retail store;

FIG. 23 is a detailed hardware configuration of an access identifying unit 63 and a charging unit 64;

FIG. 24 is a flowchart of process executed by the access identifying unit 63 and the charging unit 64;

FIG. 25 is a hardware configuration of a central control module 30; and

FIG. 26 is a hardware configuration of a processing module 131.

### DETAILED DESCRIPTION OF THE EMBODIMENTS

A embodiments will now be described through reference to the drawings. The same part or the equivalent part is assigned the same number and is not described repeatedly.

### First Embodiment

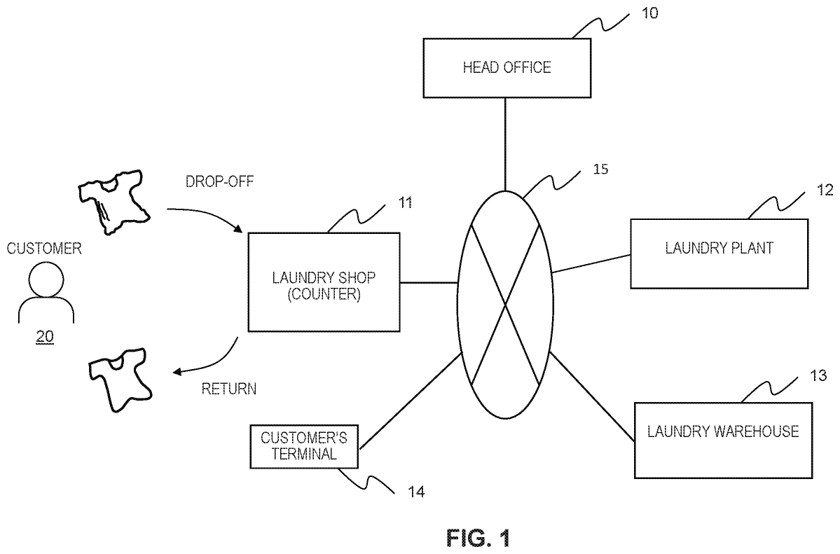

FIG. 1 is a graph of an entire system according to one embodiment. A head office 10, a laundry shop 11, a laundry plant 12, a laundry warehouse 13 and a customer's terminal 14 are connected to each other through network 15 such as the Internet. The network 15 is packet based network such as the Internet, and can include wired, wireless, optical fiber, or a combination of the three.

The head office 10 manages the entire system providing laundry service. The laundry shop 11 has a counter to which a customer 20 takes an article of clothing (hereafter, laundry article). The laundry plant 12 executes washing process. The laundry warehouse 13 keeps the laundry articles belonging to customer. The laundry shop 11 includes various types of shop that not only specialize in laundry service but also offer the service with a side job like convenience store.

The customer's terminal 14 is a computer that is interconnected with the head office 10, the laundry shop 11, the laundry plant 12 and the laundry warehouse 13 over the network 15. The customer's terminal 14 can include a personal computer, a tablet computer, a mobile terminal and a smart phone.

A franchiser administers the head office 10 that manages the entire system and provides franchisees with the framework necessary for configuring laundry service. Each franchisee, which offers the laundry service to the customer 20, administers laundry shop 11, laundry plant 12 and laundry warehouse 13 respectively.

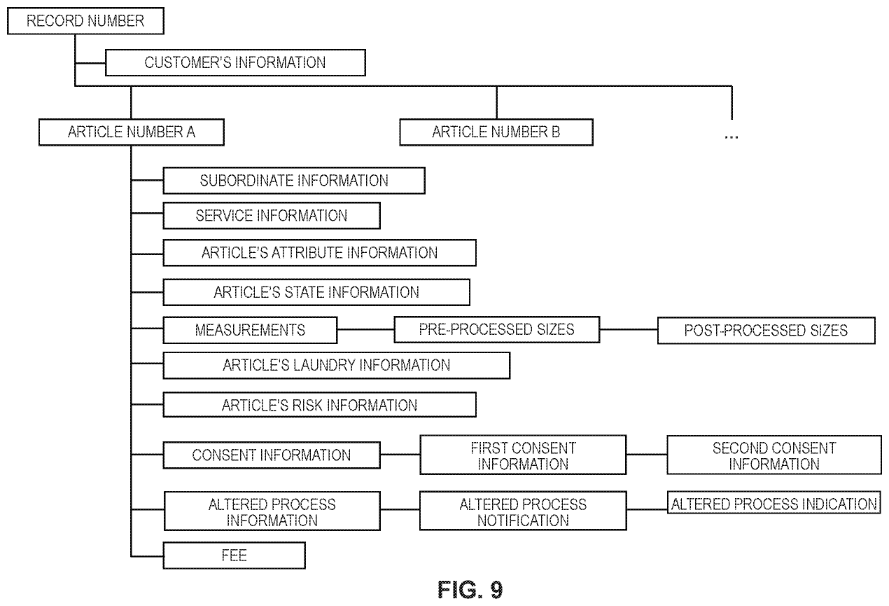

Through the network 15, such sites as the laundry shop 11, laundry plant 12 and laundry warehouse 13 request the head office 10 to browse and record the laundry records (described later with FIG. 9) that contain information related to customer's' laundry articles. Every request from the sites of browsing and recording the laundry records causes the head office 10 to charge the sites a fee. The head office 10 supports the franchisees to securely provide laundry service, for a fee, with disclosing and recording customer's′ laundry articles stored in the laundry records.

As many franchisees under a franchise typically offer customers service, it is common that a plurality of laundry shop 11, the laundry plant 12, and laundry warehouse 13 exist. FIG. 1 has, however, one laundry shop 11, one laundry plant 12 and one laundry warehouse 13 in order to simply explain the laundry charging system.

The way of how a customer 20 asks laundry service is not limited to customer's taking a laundry article to the laundry shop 11, as illustrated in FIG. 1. There may be a way of which a customer 20 directly sends a laundry article to laundry plant 13 by using some kinds of transportation service. Moreover, there may be another way of which a laundry service provider goes to a customer's house to pick up a laundry article.

Through the customer's terminal 14, the customer 20 can access and browse the wanted information related to customer's present and past laundry articles, retained at the headquarter 10.

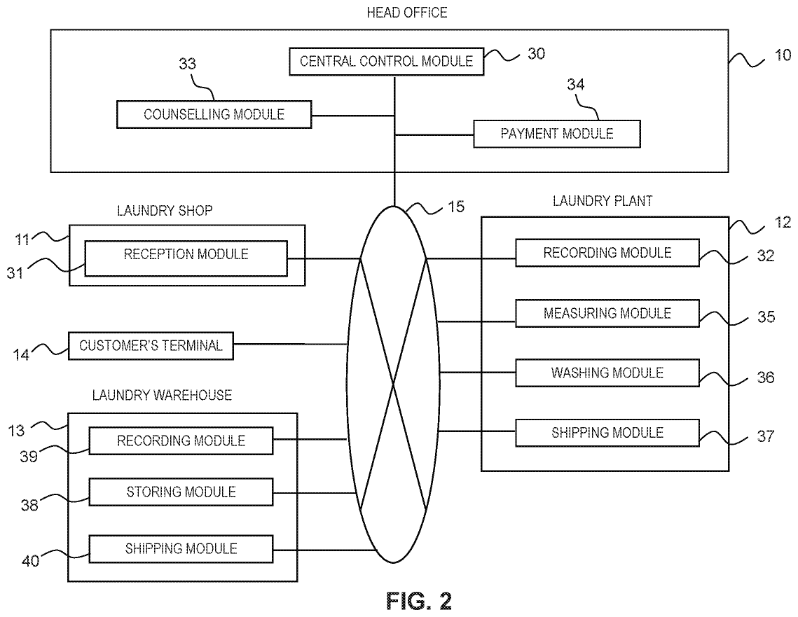

FIG. 2 illustrates a configuration of the entire system by functional module. The figure shows the function of sites such as the head office 10, laundry shop 11, laundry plant 12 and laundry warehouse 13. The following explains functions of each site by processing module.

The head office 10 has a central control module 30 to administer the entire system. The head office 10 also includes a counselling module 33 and a payment module 34, which are described later. The central control module 30, counselling module 33 and payment module 34 are connected to the network 15. The central control module 30, counselling module 33 and payment module 34 can be formed by a single electronic computer or a plurality of electronic computers, for example.

The laundry shop 11 has a reception module 31 to receive a laundry article from a customer 20. The reception module 31 tries to find whether a tag (e.g., an IC tag, a bar code, a two-dimensional code) is attached to the laundry article, and recognizes an article number held on the tag corresponding to the laundry article if the tag is attached to the laundry article.

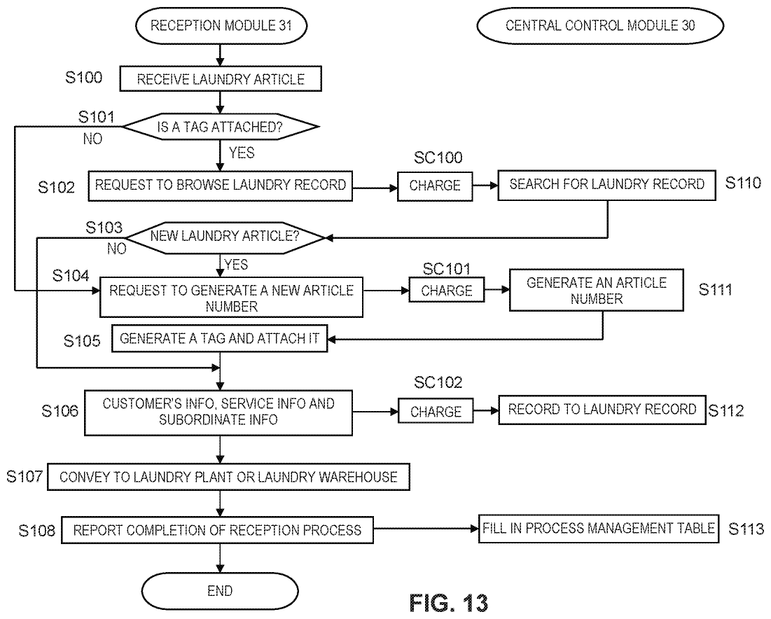

On the contrary, if it is impossible to recognize an article number due to absence or damage of the tag on the laundry article, the reception module 31 requests for issuing an article number to the central control module 30 so as to get a new article number. The reception module 31 writes the new article number to a tag and attaches the tag to the laundry article. The detailed procedure of the reception module 31 is described later with FIG. 13.

The laundry article, handled as described above, is conveyed from the laundry shop 11 to the laundry plant 12 or the laundry warehouse 13 by way of transportation undescribed here.

The laundry plant 12 includes such processing modules as recording module 32, measuring module 35, washing module 36 and shipping module 37. Each processing module functions independently to request the central control module 30 to browse and record the laundry records through the network 15.

Through the human visual inspection of the laundry article at the recording module 32 at the laundry plant 12, information including item, brand, shape, materials, colors and type of the laundry article is recorded in the laundry record as article's attribute information. Information on the laundry article including a degree of stain, semblance, tone of colors and state of materials is also recorded in the laundry record as article's state information.

At the measuring module 35, sizes of the laundry article, processed with the above-mentioned way at the recording module 32, are measured and recorded in the laundry record as sizes of the laundry article before washing process.

The laundry article is processed with washing and drying at the washing module 36. And then, the laundry article is shipped from the shipping module 37 to the customer 20. The laundry articles may be conveyed to the laundry warehouse 13 along the customer's request and be kept in the laundry warehouse 13 for the period the customer 20 wishes.

The laundry warehouse 13 has such processing modules as recording module 39, storing module 38 and shipping module 40. In the same way as the laundry plant 12, each processing module has function to independently request the head office 10 to browse and record laundry records through the network 15. Some of laundry articles brought to the laundry shop 11 by the customer 20 may be directly conveyed to the laundry warehouse 13. When the customer 20 has clothes only kept in warehouse without laundry, the laundry shop 11 conveys the clothes to the warehouse 13 directly. In this case, only the attribute information regarding to the clothes is recorded in the laundry record at the recording module 13 in the laundry warehouse 13 by an operator.

The laundry article, handled with the above-mentioned way at the recording module 39, is kept in the storing module 38 for the period the customer 20 wishes. The laundry article, wherein the period has already passed, is handled at shipping module 39 to be shipped to the customer 20. As described above, the laundry charging system includes a plurality of processing modules, which are classified whether processing module has process with intervention by an operator or not.

Processing modules with the human intervention includes reception module 31, recording modules 32 and 39, measuring module 35, washing module 36, shipping modules 37 and 40, and storing module 38. Processing modules without human intervention are counselling module 33 and payment module 34, which computationally executes predetermined processes.

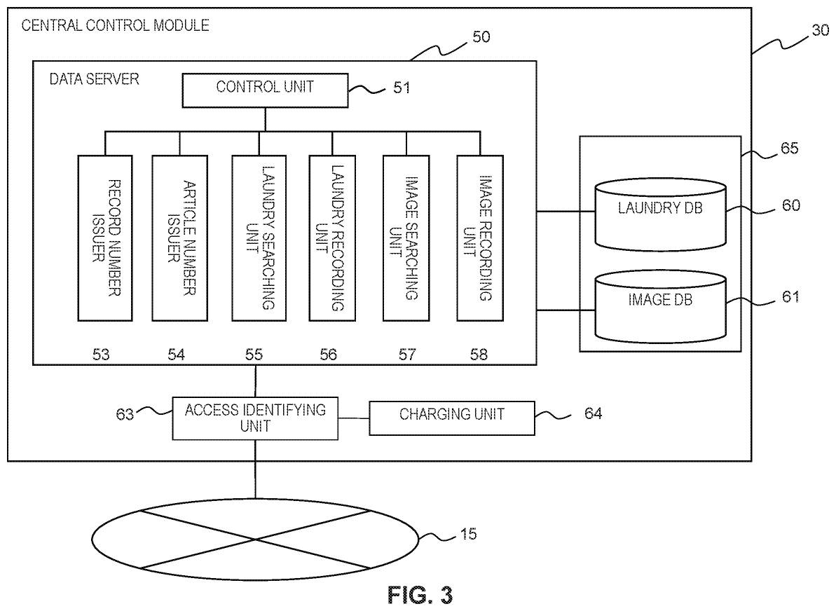

FIG. 3 illustrates configuration of the central control module 30 that includes a data server 50, a database 65, an access identifying unit 63 and a charging unit 64.

The access identifying unit 63 has a function of evaluating whether an access request made by the access source such as the laundry shop 11, a laundry plant 12, a laundry warehouse 13 and a customer's terminal 14 to the central management unit 30 relates to the laundry records.

The request of access to the laundry records includes the following cases. (1) an access source such as the laundry shop 11 and others requests the central control module 30 to browse the laundry records according to the article number, (2) an access source requests the central control module 30 to record additional information in the laundry record according to the article number, and (3) an access source requests the central control module 30 to generate an article number and to create a new laundry record corresponding to the generated article number on a laundry DB 60 (described later).

In the case of (1), the request of access by the access source causes a laundry searching unit 55 (described later) to search the laundry DB 60 for a laundry record specified by the article number and to send the laundry record back to the access source. In the case of (2), the request of access by the access source causes a laundry recording unit 56 to record specific information in the laundry record specified by the article number on the laundry DB 60. In the case of (3), the request of access by the access source causes an article number issuer 54 (described later) to generate a new article number and to create a new laundry record on the laundry DB 60 corresponding to the new article number.

Identifying an access related to the laundry records at the access identifying unit 63 enables the charging unit 64 to specify the access source from which the access is coming (in other words, to determine which of the laundry shop 11, the laundry plant 12, the laundry warehouse 13 or the customer's terminal 14 requests an access related to the laundry records) and to charge the access source for fee.

The granularity of identification of access coming from access sources may be a degree of identifying a facility such as the laundry shop 11, the laundry plant 12, the laundry warehouse 13 or the customer's terminal 14, or a degree of identifying a processing module (the reception module 31, the recording modules 32 and 39, the measuring module 35, the washing module 36, the shipping modules 37 and 40, and the storing module 38) placed in the sites. The latter degree has finer granularity than the former degree. Use of network identifier (such as IP address) originating from the access source may be a way of identifying access source.

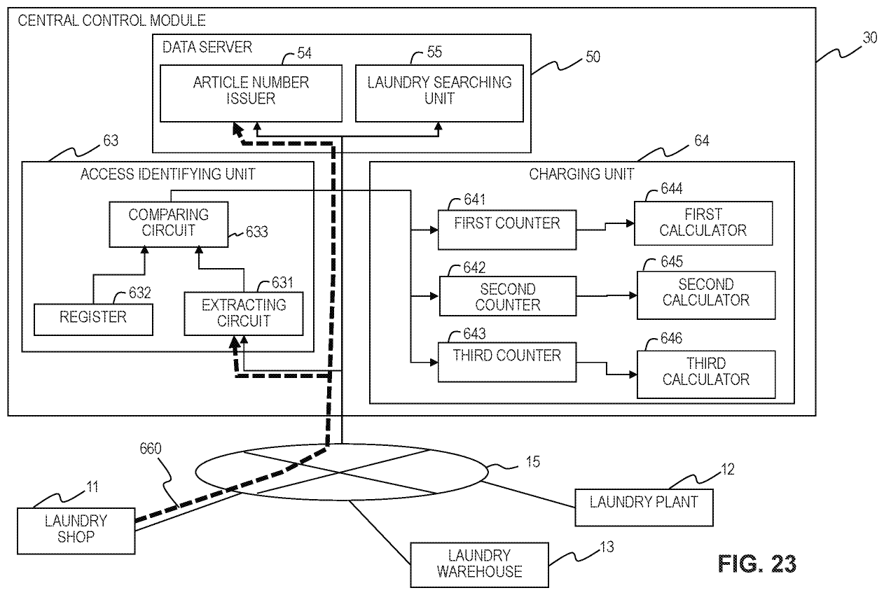

FIG. 23 shows detailed configuration of the access identifying unit 63 and the charging unit 64.

The access identifying unit 63, which is placed on the central control module 30, has extracting circuit 631, register 632 and comparing circuit 633. An access signal 660 represented by a dashed line, which is a flow of access coming from a site such as the laundry shop 11 to the central control module 30, enters the extracting circuit 631. The extracting circuit 631 extracts an access source identifier (e.g. source address on IP packet) and an access destination identifier (e.g. destination address on IP packet) from the access signal 660. The extracted access source identifier and the access destination identifier enter a comparing circuit 633.

A register 632 stores identifiers that are predetermined by a control unit or processor 51 of the data server 50, wherein the identifiers like IP addresses are assigned to the article number issuer 54 and laundry searching unit 55. Here, for convenience, each of identifiers stored in the register 632 is referred to as a first identifier.

The comparing circuit 633 compares the access destination identifier, which is extracted at the extracting circuit 631, and the first identifier, which is stored at the register 632. If the access destination identifier and the first identifier is the same value, the comparing circuit 633 outputs only the access source identifier, which is extracted at the extracting circuit 631, to the charging unit 64.

Next, first counter 641 in the charging unit 64 has a computer memory storing an identifier assigned to the laundry shop 11. Here, for convenience, the identifier is referred to as a second identifier. Moreover, the first counter 641 has an electronic circuit comparing the access source identifier outputted from the comparing circuit 633 and the second identifier stored at the memory, and a counter circuit counting the number of times that the access source identifier and the second identifier are the same value.

Similarly, second counter 642 and third counter 643 respectively include a computer memory storing an identifier assigned to the laundry plant 12 and the laundry warehouse 13. Each of the counter 642 and 643 has an electronic circuit comparing the access source identifier and the second identifier, and a counter circuit counting the number of times that both of the identifiers are the same value.

The number of times counted at the first counter 641, the second counter 642 and the third counter 643 are respectively transferred to first calculator 644, second calculator 645 and third calculator 646. The first calculator 644 is an electronic circuit that calculates fee to be charged to the laundry shop 11 based on the number of times counted by the first counter 641 and a predetermined unit fee. An example of the first calculator 644 can be an electronic circuit that determines the fee by multiplying the counted number of times by the predetermined unit fee.

Similarly, second calculator 645 and third calculator 646 respectively determine the fee for the laundry plant 12 and the laundry warehouse 13 based on the number of times from the second counter 642 and the third counter 643.

In the above description, calculation of fee is performed for each site, but the present invention is not limited to this. In the case that the calculation of fee is performed for each processing module, which has a finer granularity than on a site basis, the number of counters like the counter 641 and calculators like the calculator 644 increase accordingly.

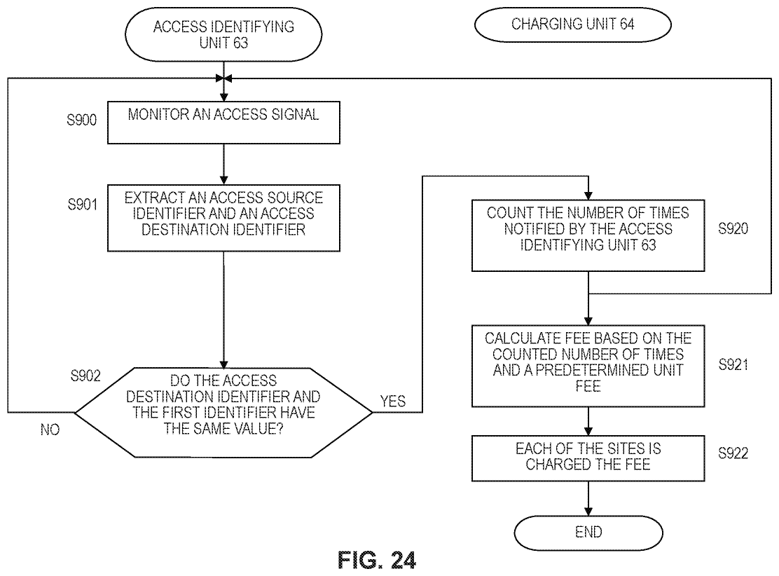

FIG. 24 shows a flowchart of process executed by the access identifying unit 63 and the charging unit 64.

First, the extracting circuit 631 of the access identifying unit 63 monitors the access signal (such as access signal 660) coming from each site to the head office 10 (S900), and extracts an access source identifier and access destination identifier included in the access signal (S901). The comparing circuit 633 compares the access destination identifier extracted by the extracting circuit 631 and the first identifier stored in the register 632 (S902). If both of the identifiers have the same value, process step goes to S920 in order for the comparing circuit 633 to transfer the access source identifier to the charging unit 64. In this case, the access signal indicates an access bound for the article number issuer 54 or laundry searching unit 55. The access signal also indicates one of the above-mentioned accesses of (1) to (3), which means that the access signal is a charging target. In the case that both of the identifiers have different value, the process step goes back to the S900.

Each of the first to third counters 641 to 643 compares the access source identifier transferred from the comparing circuit 633 and the second identifier. If the access source identifier and the second identifier are the same value, number of times that both of the identifiers have the same value is increased by one. This enables the first to third counters 641 to 643 to count the number of times notified from the access identifying unit 63 for each access source (S920).

In other words, the first counter 641 counts the number of times that the laundry shop 11 accesses the article number issuer 54 or the laundry searching unit 55, the second counter 642 counts the number of times that the laundry plant 12 accesses the article number issuer 54 or the laundry searching unit 55, and the third counter 643 counts the number of times that the laundry warehouse 13 accesses the article number issuer 54 or the laundry searching unit 55. After finishing S920, the process step goes to S921 for fee calculation and also S900 for monitoring the access signal.

Next, the first to the third calculators 644 to 646 respectively calculate fee based on the number of times counted by the first to third counters 641 to 643 and a predetermined unit fee (S921). Each of the sites is charged a fee calculated by the first to the third calculators 644 to 646 (S922). Namely, the laundry shop 11, the laundry plant 12 and the laundry warehouse 13 is respectively charged the fee calculated by the first calculator 644, the second calculator 645 and the third calculator 646.

The access identifying unit 63 and the charging unit 64 are described by hardware configuration, such as electronic circuits. But the present invention is not limited to this. A software program, which the control unit 51 in the data server 50 executes, can provide the same function of the access identifying unit 63 and the charging unit 64.

The data server 50 includes the control unit 51 controlling the whole of the data server 50 and such units controlled or functionally executed by the control unit 51 as a record number issuer 53, an article number issuer 54, a laundry searching unit 55, a laundry recording unit 56, an image searching unit 57 and an image recording unit 58.

The record number issuer 53 generates a new record number according to a request coming from the reception module 31 (which is placed in the laundry shop 11) through both the network 15 and an access identifying unit 63. The generated record number is sent back to the reception module 31, and then a new laundry record is created in the laundry DB 60 according to the generated record number. Here, the request to generate a new article number coming from the reception module 31 is only caused by the reception of a new laundry article from a new customer 20 at the laundry shop 11.

The article number issuer 54 generates a new article number according to the request from the reception module 31 (which is placed in the laundry shop 11) through both the network 15 and the access identifying unit 63. The generated article number is sent back to the reception module 31, and then a new laundry record is created in the laundry DB 60 according to the generated article number. Here, the request to generate a new article number coming from the reception module 31 is only caused by the reception of a new laundry article from an existing customer 20, which has never been processed at the laundry shop 11.

A software program executes function of the article number issuer 54. In the program, a request from the access source, such as the laundry shop 11, the laundry plant 12, the laundry warehouse 13, allows the article number issuer 54 to generate a sequential number or a random number to send the number to the access source.

The laundry searching unit 55 searches the laundry DB 60 for a laundry record by the article number, wherein the number is notified by a processing module placed in such access sources as the laundry shop 11, and sends the identified laundry record to the processing module. The laundry recording unit 56 searches the laundry DB 60 for a laundry record based on the article number, wherein the number is notified by a processing module placed in access sources, records new and/or updated information on the identified laundry record.

The image searching unit 57 searches the image DB 61 for an image of a laundry article by the article number, wherein the number is notified by a customer's terminal 14, and sends the identified image to the customer's terminal 14. This allows the customer 20 to browse the image of the laundry article before, after and under the washing process through the customer's terminal 14. The image recording unit 58 writes and records an image of a laundry article, based on the article number, on the image DB 61 according to the request from the measuring module 35 and washing module 36 placed in the laundry plant 12.

The laundry DB 60 in the database 65 is a database (e.g., a computer storage device) that stores the laundry records, illustrated in FIG. 9, in a searchable form by an article number. The laundry records in the laundry DB 60 are searched, browsed, and rewritten through the laundry searching unit 55 and laundry recording unit 56.

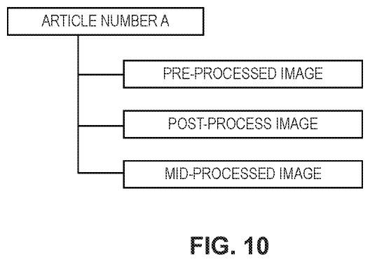

The image DB 61 is a database storing pre-processed, post-processed and mid-processed images of the laundry article, illustrated in FIG. 10, in a searchable form by an article number. The pre-processed, post-processed and mid-processed images mean the images photographed before, after and under the washing process, respectively. The images on the image DB 61 are searched, browsed, and recorded through the image searching unit 57 and image recording unit 58.

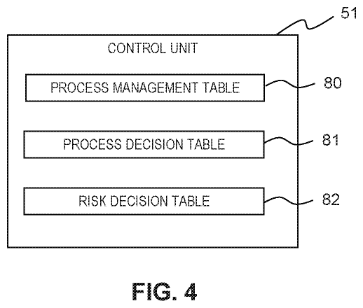

The control unit 51 has a plurality of tables prestored in memory as illustrated in FIG. 4 in addition to function of controlling units placed in the data server 50.

A process management table 80 indicates progress of processing a laundry article by each article number, wherein every module having finished each process reports completion of the process to the central control module 30 through the network 15. Examining the table 80 allows the control unit 51 to grasp the progress by each article number and allows each processing module to decide which of laundry articles should be processed.

A process decision table 81 is a data table to decide what laundry method is suitable to a laundry article in terms of attribute and state of the laundry article (hereafter, the laundry method is called “article's laundry information”). The article's laundry information is uniquely decided by the attribute of the laundry (hereafter “article's attribute information”) and state of the laundry (hereafter “article's state information”)

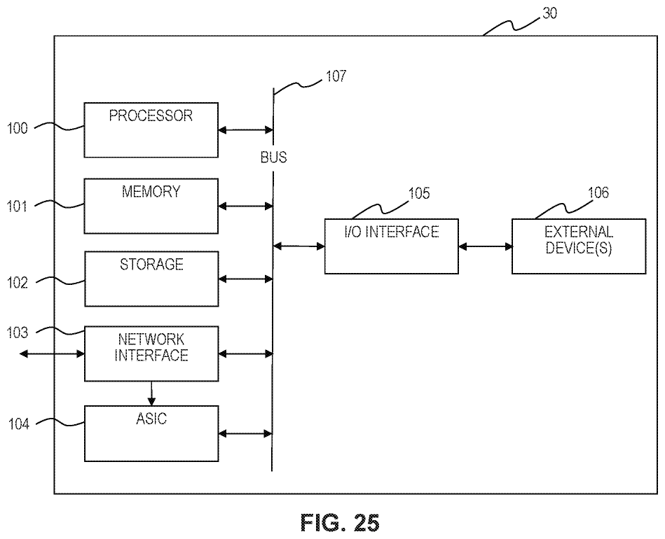

The process decision table 81 is stored on a computer memory 101 in the central control module 30 depicted in the FIG. 25 to be configured to directly search the article's laundry information based on the article's attribute information and the article's state information. An example of the process decision table 81 may be data table with row having the article's attribute information and the article's state information and column having the article's laundry information.

A risk decision table 82 is a data table to estimate what damage a laundry article probably suffers during washing process in terms of the article's attribute information and article's state information (hereafter the estimated damage is called “article's risk information”). Like the above-mentioned article's laundry information, the article's risk information is uniquely estimated by the article's attribute information and article's state information.

The risk decision table 82 is stored on the memory 101 in the central control module 30 depicted in the FIG. 25 to be configured to directly search the article's risk information based on the article's attribute information and the article's state information. An example of the risk decision table 82 may be data table with row having the article's attribute information and the article's state information and column having the article's laundry information.

In counseling process later described that is prior to the washing process, a customer 20 is notified the article's laundry information and article's risk information via the customer's terminal 14. In the case that the customer 20 consents to the article's laundry information and article's risk information, the customer 20 tells the system to agree the process and risk by a message (hereafter “first consent information”).

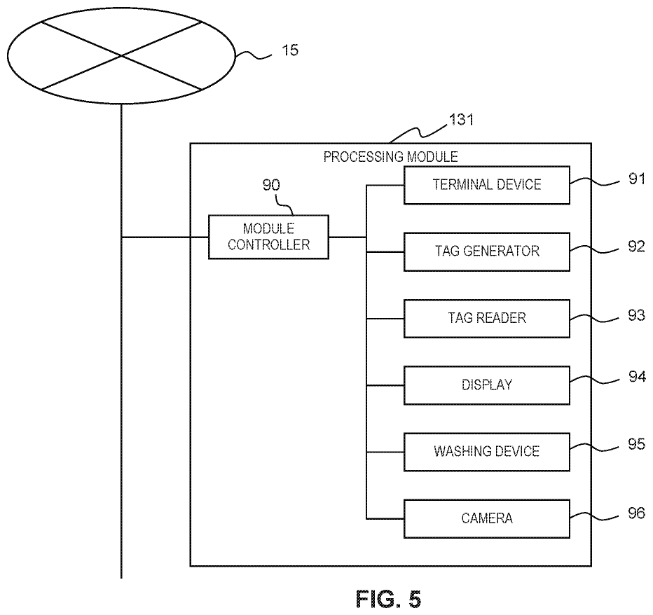

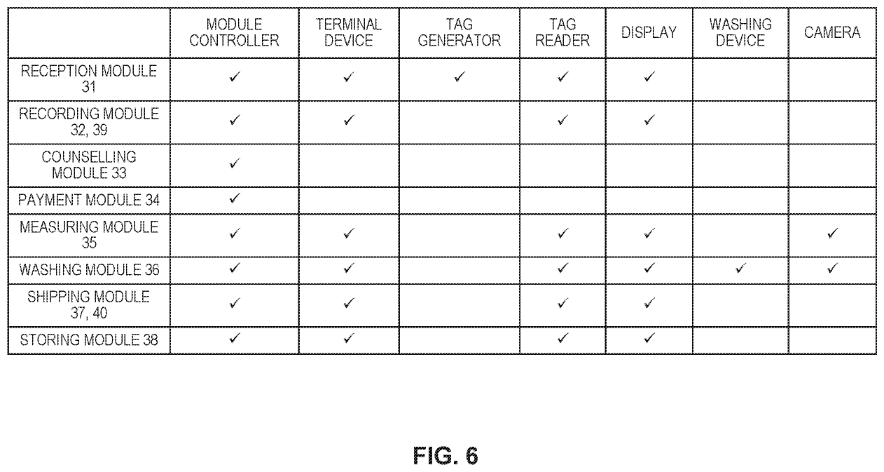

A configuration of a processing module is illustrated in FIGS. 5 and 6. FIG. 5 shows typical configuration of such a processing module with human intervention as reception module 31, recording modules 32 and 39, measuring module 35, washing module 36, shipping module 37 and 40, and storing module 38. A processing module 131 includes all devices used in the above-mentioned processing modules.

A module controller 90 in the processing module 131 has functions not only to communicate other processing modules and customer's terminal 20 via the network 15 but also to control the entire module 131. Devices such as a terminal device 91, a tag generator 92, a tag reader 93, a display 94, a washing device 95 and a camera 96 are connected to the module controller 90.

The terminal device 91 allows an operator to input data when doing predetermined process (which includes a reception process to receive a laundry article of the customer 20 at the counter and a recording process to input information related to type and shape of a laundry article via the device 91). The tag generator 92 writes an article number sent from the central control module 30 to an IC-tag and/or generates a barcode corresponding to the article number. The IC-tag and/or the barcode is attached to the laundry article. The tag generator 92 is installed only in the reception module 31.

The tag reader 93 reads a tag attached to a laundry article and identifies an article number corresponding to the laundry article. The display 94 shows a laundry record about a laundry article and the process management table 80. The information displayed on the display 94 allows an operator to certainly proceed with process.

The tag reader 93 may be a barcode reader that is an optical scanner able to scan a printed barcode and to obtain the article number in the barcode. The tag reader 93 also may be a RFID (Radio Frequency Identification) IC tag reader, which transmits magneto-electric signal to a RFID IC chip and receives reflected signal from the RFID IC to obtain the article number memorized in the RFID IC.

The washing device 95 includes all devices necessary to do laundry such as washing machines. The washing device 95 is installed only in the washing module 36. The camera 96 aims to take images of laundry articles before, after and under execution of washing process, which is placed in the measuring module 35 and the washing module 36.

The processing module 131 has all of the devices as mentioned above, while each of processing module does not necessarily have all of them. FIG. 6 shows devices equipped at each processing module. For example, the reception module 31 has the module controller 90, the terminal device 91, the tag generator 92, the tag reader 93, and the display 94. The storing module 38 includes the module controller 90, the terminal device 91, the tag reader 93, and the display 94. FIG. 6 shows that the counselling module 33 and the payment module 34 have only the module controller 90. This is because these two modules execute processes without human intervention.

A structure of the laundry DB 60 is illustrated in FIG. 9. FIG. 9 shows structure of laundry records stored in the laundry DB 60. A laundry record has a record number corresponding to customer's information. A plurality of article numbers, each of which represents a customer's laundry article, are disposed under the record number.

Each of article numbers is followed by information such as attribute of laundry article, service contents of laundry and fee of laundry, which is searchable by an article number. Each piece of information is described below. A record number is a different number given to a different customer. Customer's information is the same as customer's contact information including customer's name, telephone number, FAX number and e-mail address.

An article number, generated at the central control module 30, is a different number given to a different laundry article. An IC-tag or a barcode containing the article number is attached to a laundry article that is brought at the reception module 31 by a customer for the first time ever.

Subordinate information means two or more customer's laundry articles may consist of a main laundry article and secondary laundry articles. The information is recorded in the laundry records by an operator at the reception module 31, if needed. If, for example, customer's laundry articles consist of a suit and a belt, the suit is regarded as a main laundry article and the belt is regarded as a secondary laundry article. Different washing process is applied to each of them at the laundry plant 12. After finishing the washing process, they are again assembled at the shipping module 37 to be sent back to the customer as a pack of laundry articles.

Moreover, the subordinate information is used for connecting with each delivery area of customer's laundry articles. In the case that plural laundry articles should be delivered to the same area, one of them is labeled a main article and others are labeled secondary articles. Shipping the labeled articles by region reduces cost.

Also, the subordinate information is used to send some laundry articles to a customer earlier than other laundry articles. It is a kind of distributed shipping. For example, five of ten articles labeled with the information are sent early to the customer and remaining five articles are sent later as a pack.

Namely, the subordinate information has purpose to synchronize shipping processes, which is final process in the entire laundry service, of plural laundry articles brought by a customer although different washing process applies to the different article in the laundry plant 12.

Service information indicates type of service a customer wants. There are three kinds of service, only laundry; laundry and storing; and only storing.

Article's attribute information on a laundry article includes item, brand, shape, materials, colors, type, summer clothes, winter clothes and date of purchase. Article's state information on a laundry article includes degree of stain, semblance, tone of colors, state of materials, silhouette, blot, damaged portion and cause of damage.

Pre-processed and post-processed sizes in measurements indicate sizes of all portions of a laundry article before and after execution of the washing process, respectively.

Article's laundry information, decided by the process decision table 81 in the control unit 51 on the basis of article's attribute information and article's state information, indicates what laundry method is applied to a customer's laundry article.

Article's risk information, decided by the risk decision table 81 in the control unit 51 on the basis of article's attribute information and article's state information, indicates potential damage (namely, risk) and irresistible force for a laundry article during the washing process.

In consent information, the first consent information indicates whether a customer consents to article's laundry information and article's risk information that are notified the customer under the counseling process. Customer's consent to the first information allows the washing process to be executed according to the article's laundry information, while customer's expression of dissent causes the washing process not to be executed. The second consent information indicates whether a customer approves continuing the execution of the washing process in case some disorder happens during the washing process. Customer's consent to the second information allows the washing process to be continued, while customer's dissent results in suspending the washing process.

Altered process information indicates alteration of the washing process due to occurrence of disorder during the washing process. Altered process notification is a message that asks a customer whether the washing process should be continued in case of disorder during the washing process. Altered process indication is an instruction, given by the customer, of continuing or suspending the washing process.

A structure of the image DB 61 is illustrated in FIG. 10. FIG. 10 shows structure of the image DB 61 that provides function searching images of the laundry article before, after and under the washing process by an article number.

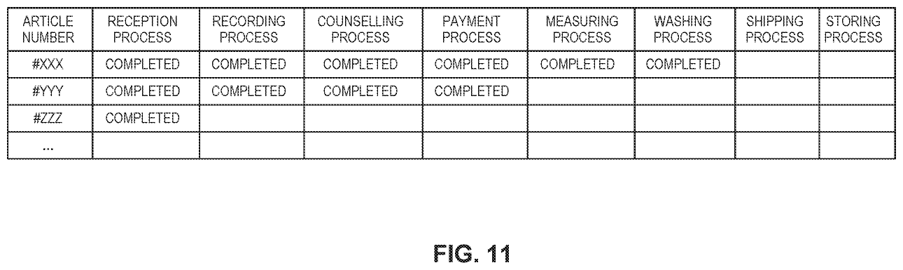

2.3. A structure of the process management table 80 is illustrated in FIG. 11. FIG. 11 shows structure of process management table 80 placed in the control unit 51. The table keeps records of progress of processes by a customer's laundry article. On the completion of the predetermined process, each processing module reports the completion of the process with an article number to the control unit 51 through the module controller 90. The control unit 51 records received reports of completion to the process management table 80 according to a customer's article number.

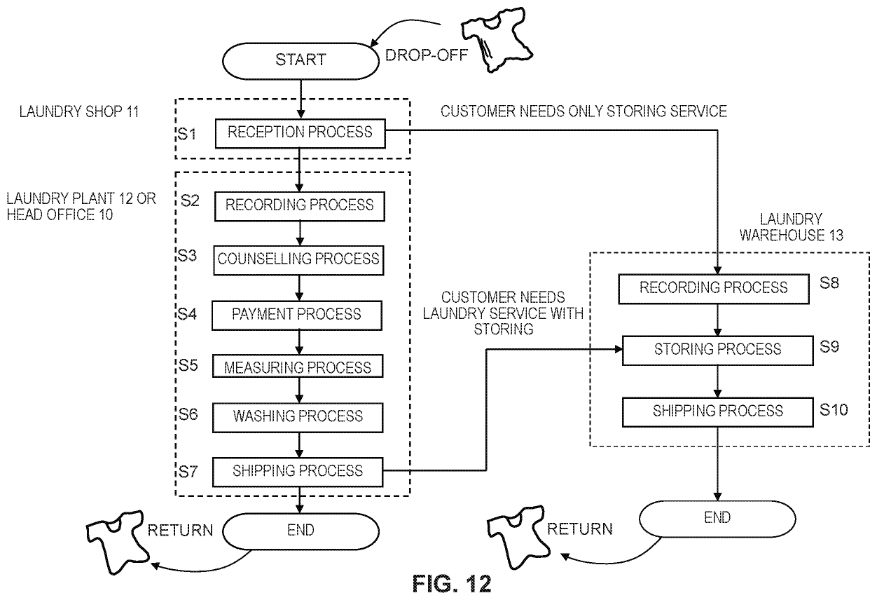

A processing flow is illustrated in FIG. 12. FIG. 12 illustrates the entire procedure of the laundry charging system in accordance with one embodiment.

First, a laundry article, taken to by a customer, is handled with reception process at a laundry shop 11 (S1).

A tag, which contains an article number generated by the head office 10, is attached to the laundry article that is handled on the laundry charging system for the first time ever, and then information such as customer's name, customer's contact is recorded on the laundry records according to the article number.

On the contrary, a laundry article with a tag, which has been handled before, is handled just to read the tag and finished the reception process. This is because information such as customer's name, customer's contact is already known. Customer's two or more laundry articles may be classified into the main article and secondary article, which are recorded to the laundry records if needed.

Here, if the customer needs service including laundry service (in other words, the service is only the laundry service or the laundry service with storing service), the procedure goes to the recording process (S2) executed at the laundry plant 12. Therefore, the laundry article moves from the laundry shop 11 to the laundry plant 12. If the customer needs only the storing service, the laundry article moves to the laundry warehouse 13 where the recording process (S8) is executed.

At the recording process (S2, S8), an operator inspects the laundry article to get the article's attribute information and article's state information, and to enter the information to the terminal device 91 so as to record the information in the laundry DB 60 according to the article number.

At the counselling process (S3), the process decides the method of laundry through dialogue with the customer while proposing the method of laundry and potential risk (disorder) to the customer. The process also obtains customer's consent to the risk. The decided method of laundry and the customer's consent to the risk are recorded in the laundry DB 60 as the article's laundry information and article's risk information respectively, according to the article number.

The counselling process offers fee to the customer, makes consent to it with customer. Basically, the whole counselling process (S3) is computationally executed. Communication with customer is realized by web-based interactive way, wherein the information necessary for the customer is displayed on the customer's terminal 14.

On finishing the counselling process, the procedure goes to payment process (S4), which is followed by a series of processes relating to laundry work (such as measuring process and washing process). At the measuring process (S5), each portion of the laundry article, before the washing process, is measured and photographed. The sizes and photographs are recorded in the laundry DB 60 and image DB 61 respectively, according to the article number. In the laundry charging system, the measuring process follows the counselling process, while the counselling process, conversely, may follow the measuring process.

The washing process (S6) executes washing the laundry article on the basis of the article's laundry information. Occurrence of disorder during the washing process immediately causes the washing process to inform the customer of the disorder and to ask the customer whether the washing process should be continued or suspended. The washing process subsequently continues or suspends in compliance with customer's response. In case of disorder, gathered information and taken photographs related to the disorder are recorded in the laundry DB 60 and image DB 61 respectively, according to the article number.

Each of the shipping process (S7, S10) executes process of packing and shipping a customer's laundry article by each article number. Packing and shipping the laundry articles labeled with subordinate information begin just after a main laundry article and all of the secondary laundry articles are completely collected.

In the storing process (S9), a laundry article is kept at the laundry warehouse for the period the customer wishes.

FIG. 13 shows the procedure of reception process, executed in the reception module 31 placed at the laundry shop 12. When the laundry shop 11 receives a customer's laundry article at the counter (S100), the operator checks attachment of a tag (e.g., an IC tag, a barcode, a two-dimensional code) to the article (S101). Finding no tag with the article means the article is new and has not been processed before in the system, so that the reception module 31 requests the central control module 30 to generate a new article number (S104).

In the case that the laundry article is tagged, this allows tag reader 93 to sense the tag and to obtain the article number corresponding to the laundry article. An operator requests the central control module 30 in the head office 10 to browse the laundry record based on the article number obtained (S102).

When an access request from the reception module 31 of browsing the laundry records is made, the access identifying unit 63 in the central control module 30 evaluates type of the access request. As browsing the laundry record is one of access requests to the laundry searching unit 55, the access identifying unit 63 instructs the charging unit 64 to execute calculation for charging the reception module 31 (SC100).

And then, the laundry searching unit 55 searches the laundry DB 60 for the laundry record by the article number sent from the reception module 31. If the corresponding laundry record is successfully found, the laundry record is sent back to the reception module 31. On failing to find it, the reception module 31 is notified the failure (S110).

When the reception module 31 is notified the failure from the central control module 30 (S103), the reception module 31 finds that the customer's laundry article is a new one and has not been processed in the system in the past. Therefore, the reception module 31 requests the central control module 30 to generate a new article number (S104) in order to handle the article with a tag having the article number.

When a request of issuing an article number from the reception module 31 is made, the access identifying unit 63 in the central control module 30 evaluates type of access request. As the request is one to the article number issuer 54, the access identifying unit 63 instructs the charging unit 64 to execute calculation for charging the reception module 31 (SC101).

Next, the request from the reception module 31 causes the article number issuer 54 to generate an article number and to send back the number to the reception module 31 (S111). The reception module 31, which has received the article number from the article number issuer 54, generates a tag containing the number by the tag generator 92 and attaches the tag to the new laundry article (S105). After this, the laundry article is consistently handled with the article number at every processing module in the system.

An operator inspects the customer's laundry article tagged with the article number, with additional question to the customer at counter, to obtain information such as customer information, service information and subordinate information, and then records the information to the laundry records (S106).

The access request, from the reception module 31, of recording the information to the laundry DB 60 causes the access identifying unit 63 to evaluate a type of access. And then, the charging unit 64 executes calculation for charging the reception module 31 (SC102). Thereafter, recording to the laundry DB 60 is done through the laundry recording unit 56 (S112).

In the case that the customer's laundry article is found not a new article at S103, which means the article has already a tag with an article number, an operator only inspects whether the article should be added subordinate information at S106, searches the laundry DB 60 for the corresponding laundry record, and records the information in the laundry record. As a laundry article is not a new one, the customer's information corresponding to the laundry article is already recorded in the laundry record, so that no additional registration of customer's information is required except altering the information due to the request of customer 20.

After the necessary information is recorded in the laundry record, the laundry article is conveyed to the laundry plant 12 or the laundry warehouse 13 in compliance with the service information (S107). Namely, the laundry article moves to the laundry warehouse 13 if the service information says that the customer 20 wishes only the storing service.

Completion of conveying the laundry article to the laundry plant 12 or the laundry warehouse 13 allows an operator to report completion of the reception process to the head office 10 through the terminal device 91 (S108).

The central control module 30 in the head office 10 treats notice of completion from the reception module 31. Namely, the control unit 51 in the central control module 30 fills in “reception” column in the process management table 80 with “completed” on the basis of the article number so as to record the notice of completion in the table 80. Thereafter, the laundry article advances to the recording process.

Reporting completion of the reception process from the reception module 31 is also checked by the access identifying unit 63 to evaluate which destination of the access is, wherein the access of reporting completion of the reception process is an access bound for the process management table 80 in the control unit 51. As the access is not bound for the article number issuer 54, the laundry searching unit 55 or the laundry recording unit 56, the access identifying unit 63 instructs the charging unit 64 not to execute calculation for charging.

The access identifying unit 63 evaluates the destination in the central control module 30 of every access carried out by all processing modules and identifies only access bound for the destination such as the article number issuer 54, laundry searching unit 55 and laundry recording unit 56, so as for the charging unit 64 to execute calculation for charging by each processing module. In other words, the access identifying unit 63 identifies only access to the destination of the laundry DB 60, which stores the laundry records, and the charging unit 64 executes calculation for charging by each processing module.

In the laundry charging system, the most important resource is the laundry records that store information related to customer's laundry articles. A franchiser aims to charge fee for access to the laundry records in exchange for permitting franchisees freely to use the laundry records and to provide customers with laundry service.

At the recording module 32, a tag reader 93, with the human operation (or automatically), reads a tag attached to the laundry article to obtain an article number. Next, the recording module 32 requests the head office 10 to search for and browse a laundry record according to the article number (S200).

At the head office 10 that has received the access request of browsing the laundry record, the charging unit 64 executes calculation of fee for the recording module 32 (SC200). Thereafter, the laundry searching unit 55 searches the laundry DB 60 for the laundry record by the article number, and then sends back the laundry record to the recording module 32 (S210).

The laundry record sent back to the recording module 32 is shown on the display 94 placed in the recording module 32. Looking at the display 94, an operator begins to put the data regarding the laundry article into the terminal device 91 (S201). Specifically, the operator enters the article's attribute information and article's state information, obtained by inspection, in the terminal device 91 with monitoring the display 94 (S202). Alternatively, the article's attribute information and article's state information obtained by an image recognition of the laundry article may be automatically entered (S202). Entered Information is indicated on the display 94 and is sent to the head office 10 to be recorded on the basis of the article number.

At the head office 10 that has received the access request of recording to the laundry record, the charging unit 64 executes calculation of fee for the recording module 32 (SC201). Thereafter, the laundry recording unit 56 searches the laundry DB 60 for a laundry record by the article number, and writes the article's attribute information and article's state information, received from the recording module 32, onto the laundry record (S211).

After the recording module 32 has sent the article's attribute information and article's state information to the head office 10, an operator reports completion of the recording process to the head office 10 through the terminal device 91 (S203).

In the head office 10, the central control module 30 treats notice of completion from the recording module 32. Namely, the control unit 51 in the central control module 30 fills in “recording” column in the process management table 80 with “completed” on the basis of the article number so as to record the completion notice in the table 80 (S212). Thereafter, the laundry article advances to the measuring process. The recording module 39 in the laundry warehouse 13 works in the same way as the recording module 32.

The central control module 30 confirms the completion of the recording process through the process management table 80, and notifies an article number, which corresponds to the completion of the recording process, to the counselling module 33 (S320).

The counselling module 33, which has received the article number (S300), requests the central control module 30 to search for and browse the laundry record according to the article number (S301).

At the central control module 30 that has received the access request of browsing the laundry record, the charging unit 64 executes calculation of fee for the counselling module 33 (SC300). Thereafter, the laundry searching unit 55 searches the laundry DB 60 for the laundry record by the article number, and sends back the laundry record to the recording module 32 (S321).

The counselling module 33, which has received the laundry record, extracts contact information such as e-mail address of the customer 20 from the laundry record. And then, the counselling module 33 sends e-mail of guidance, which asks the customer 20 to get counselling via web, to the customer's terminal 14 in order to interact and agree with the customer 20 about how to clean the laundry article (S302).

The customer 20, received the guidance for counselling (S340), makes an inquiry to the counselling module 33 according to the guidance displayed on the customer's terminal 14 (S341).

The counselling module 33 receives the request from the customer's terminal 14, and sends the laundry record of the customer's laundry article back to the customer's terminal 14 (S342). The customer 20, if necessary, revises and updates the customer's attribute information and customer's state information of the laundry record, which are displayed on the customer's terminal 14, to send them back to the counselling module 33 (S343). Even if the customer 20 needs no revision of the laundry record, the laundry record is sent back to the counselling module 33.

The counselling module 33 sends the laundry record, received from the customer's terminal 14, to the central control module 30, which overwrites the laundry record on the laundry DB 60 (S322). Here, “overwrite” means that the counselling module 33 replaces an existing laundry record with a new one to write the new one on the laundry DB 60 if the laundry record has been revised or updated by the customer's terminal 14, while the counselling module 33 writes just the existing laundry record on it if the laundry record has not been revised or updated.

Next, the central control module 30 searches process decision table 81 and risk decision table 82, which are in the control unit 51, for article's laundry information and for article's risk information according to the article's attribute information and article's state information in the laundry record sent from the counselling module 33. This results in deciding washing process and specifying potential risk during the washing process (S323, S324). The specified article's laundry information and article's risk information are sent to the counselling module 33 (S324).

The article's laundry information and article's risk information, both of which are received at the counselling module 33, are directly sent to the customer's terminal 14 (S305) and displayed on the customer's terminal 14 (S344). Delivery date is also shown on it.

The counselling module 33 sends a message to the customer's terminal 14 to ask for customer's consent to the above-mentioned information including the article's laundry information, article's risk information and delivery date (S307). The message is displayed on the customer's terminal 14 (S346). After the customer enters information expressing customer's consent into the customer's terminal 14, the information is sent to the counselling module 33 (S347).

The counselling module 33 receives the consent information, which is regarded as first consent information, and then requests the central control module 30 to record the information in the laundry record based on the article number (S308). At the central control module 30 that has received the access request of recording the first consent information in the laundry record, the charging unit 64 executes calculation of fee for the counselling module 33 (SC302). Thereafter, the laundry recording unit 56 records the first consent information in the laundry DB 60 (S326).

Subsequently, the counselling module 33 notifies the central control module 30 of completion of the counselling process (S309). At the central control module 30, the control unit 51 fills in “counselling” column in the process management table 80 with “completed” on the basis of the article number so as to record the completion notice in the table 80 (S327). Thereafter, the laundry article advances to the payment process.

As above mentioned, receiving customer's first consent to the article's laundry information and article's risk information allows the following washing process to be executed, in order to prevent the customer's misunderstanding during web-based counselling and potential accident during the washing process.

The central control module 30 confirms the completion of the counselling process through the process management table 80, and then notifies an article number, whose laundry article is in completion of the counselling process, to the payment module 34 (S420). The payment module 34, which has received the article number (S400), asks the central control module 30 laundry fee according to the article number (S401).

The central control module 30, which has received the article number and inquiry of laundry fee, instructs the laundry searching unit 55 to search for a laundry record by the article number to get article's laundry information (S421). The central control module 30 calculates laundry fee on the basis of the article's laundry information to send the laundry fee to the payment module 34 (S422). Here, the central control module 30 records the calculated fee in the laundry record according to the article number.

The payment module 34, which has received the data regarding the laundry fee, sends it to the customer's terminal 14 (S402), so that it is displayed on the customer's terminal 14 (S440).

The customer consents to the fee displayed on the customer's terminal 14 to enter payment data into the terminal (S441), so that the payment module 34 executes procedure of payment (S403). There are various ways entering payment data into the customer's terminal 14, such as reading a barcode or RFID linked to payment data via a smart phone or accessing to settlement institution via a smart phone. And also, the payment data described here has many forms including credit card, internet banking, settlement at a convenience store and bank settlement.

Subsequently, the payment module 34 notifies the central control module 30 of completion of the payment process (S404). At the central control module 30, the control unit 51 fills in “payment” column in the process management table 80 with “completed” on the basis of the article number so as to record the notice of completion in the table 80 (S423). Thereafter, the laundry article goes to the measuring process.

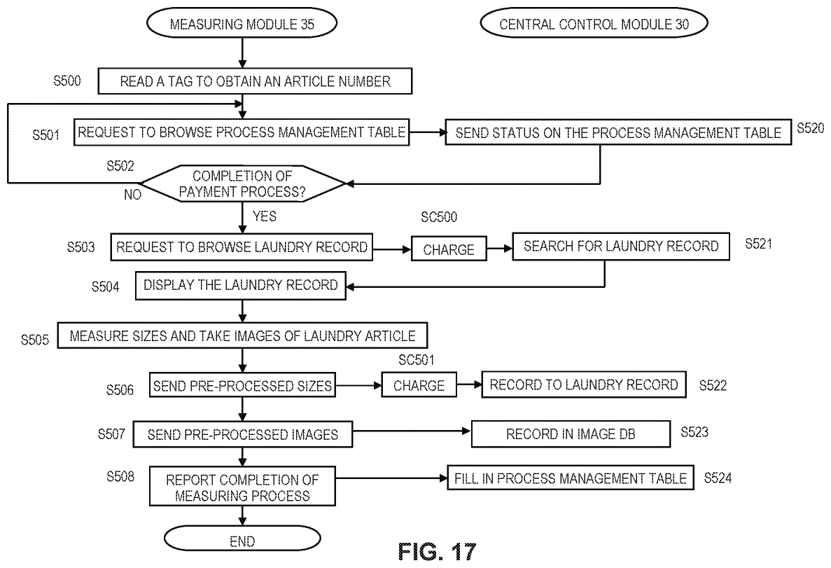

The flow of measuring process is illustrated in FIG. 17. At the measuring module 35, an operator uses a tag reader 93 to read a tag attached to the laundry article to obtain an article number (S500). And then, the measuring module 35 requests the head office 10 to browse the process management table 80 according to the article number (S501).

The head office 10, which has received the access request of browsing the process management table 80, sends the status filled in “payment” column on the table 80 based on the article number to the measuring module 35 (S520).

If the status in the process management table 80, transferred from the head office 10, indicates completion of the payment process, the measuring process 35 proceeds to the next step (S501). The measuring module 35 requests the head office 10 to search for and browse the laundry record according to the article number (S503).

At the head office 10 that has received the access request of browsing the laundry record, the charging unit 64 executes calculation of fee for the measuring module 35 (SC500). Thereafter, the laundry searching unit 55 searches the laundry DB 60 for the laundry record by the article number, and sends back the laundry record to the measuring module 35 (S521).

The laundry record sent back to the measuring module 35 is shown on the display 94 in the measuring module 35 (S504). Looking at the display 94, an operator enters the measured sizes of laundry article into the terminal device 91 and takes images of whole and each portion of the laundry article (S505).

The measuring module 35 sends the measured sizes to the head office 10 to be recorded in the laundry record as pre-processed sizes (S506). At the head office 10 that has received the access request of recording to the laundry record, the charging unit 64 executes calculation of fee for the measuring module 35 (SC501). Thereafter, the laundry recording unit 56 searches the laundry DB 60 for the laundry record by the article number, and writes the pre-processed sizes on the laundry record (S522).

Next, the measuring module 35 sends the taken images to the head office 10 to be recorded in the image DB 61 as pre-processed images (S507). At the head office 10, the image recording unit 58 records the pre-processed images, based on the article number, in the image DB 61 (S523).

Subsequently, the measuring module 35 reports completion of the measuring process to the head office 10 (S508). The completion report is treated at the control unit 51 in the central control module 30, which fills in “measuring” column in the process management table 80 with “completed” on the basis of the article number so as to record the notice of completion in the table 80 (S524). Thereafter, the laundry article advances to the washing process.

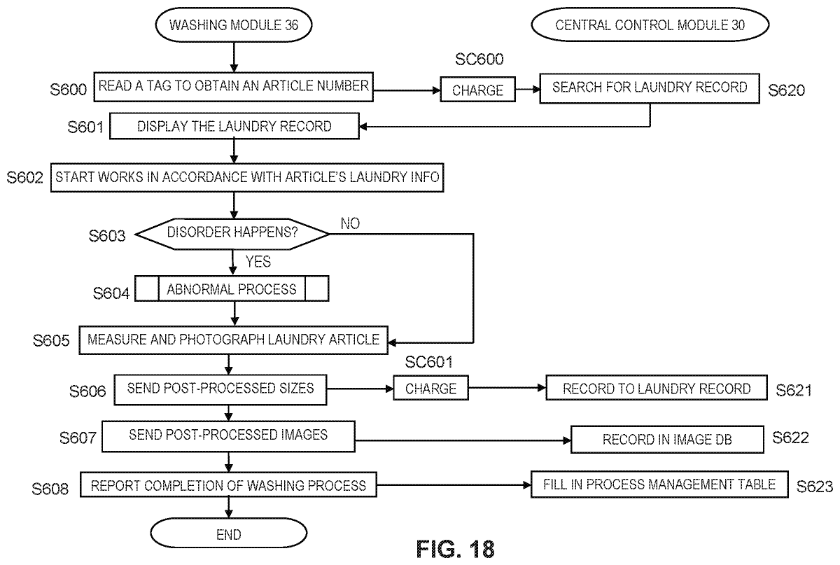

The flow of the washing process is illustrated in FIG. 18. At the washing module 36, an operator uses a tag reader 93 to read a tag attached to the laundry article to obtain an article number (S600). And then, the washing module 36 requests the head office 10 to search for and browse a laundry record according to the article number.

At the head office 10 that has received the access request of browsing the laundry record, the charging unit 64 executes calculation of fee for the washing module 36 (SC600). Thereafter, the laundry searching unit 55 searches the laundry DB 60 for the laundry record by the article number, and then sends back the laundry record to the washing module 36 (S620).

The laundry record sent back to the washing module 36 is shown on the display 94 in the washing module 36. An operator starts works such as washing the laundry article in accordance with the article's laundry information shown on the display 94 (S602).

The following describes the procedure taken in case that no disorder happens during the washing process (S603). The procedure in case of disorder, namely abnormal process, is described later.

After finishing works such as washing the laundry article based on the article's laundry information, the laundry article is measured and photographed (S605). The washing module 36 requests the head office 10 to record the measured data to the laundry record as post-processed sizes (S606).

At the head office 10 that has received the access request of recording the laundry record, the charging unit 64 executes calculation of fee for the washing module 36 (SC601). Thereafter, the laundry recording unit 56 searches the laundry DB 60 for the laundry record by the article number, and records the post-processed sizes, received from the washing module 36, on the laundry record (S621).

Next, the washing module 36 requests the head office 10 to record the photographed images in the image DB 61 as post-processed images (S607).

At the head office 10 that has received the access request of recording the post-processed images, the image recording unit 58 records the images in the image DB 61 (SC622).

Subsequently, the washing module 36 reports completion of the washing process to the head office 10 (S608). The completion report is treated at the control unit 51 in the central control module 30, which fills in “producing” column in the process management table 80 with “completed” on the basis of the article number so as to record the notice of completion in the table 80 (S623). Thereafter, the laundry article advances to the shipping process.

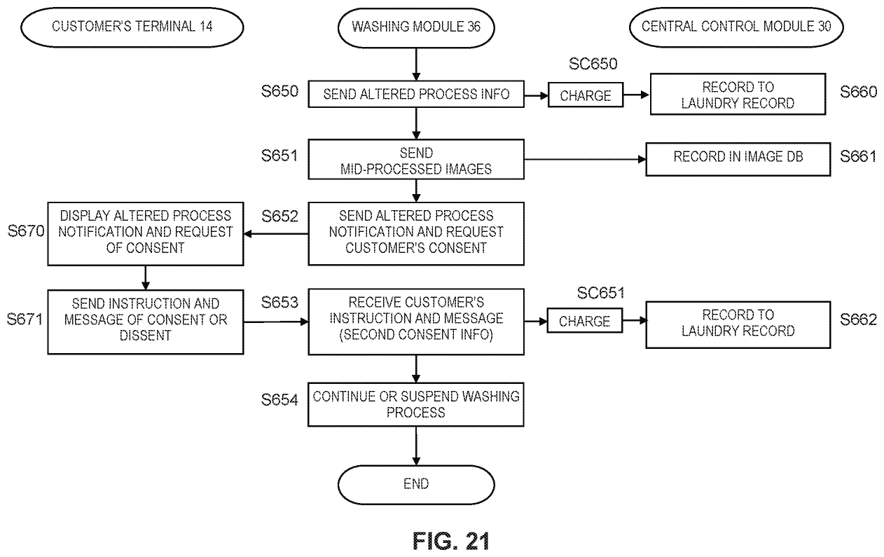

The flow of the abnormal process is illustrated in FIG. 21. Detection of a disorder during the washing process, by some method that is not described here, causes the washing module 36 to request the head office 10 to record a message (altered process information), which indicates alteration of washing process due to occurrence of the disorder, to the laundry record (S650).

At the head office 10 that has received the access request of recording into the laundry record, the charging unit 64 executes calculation of fee for the washing module 36 (SC650). Thereafter, the laundry recording unit 56 records the altered process information, received from the washing module 36, in the laundry record (S660).

Next, the washing module 36 takes images related to the disorder by the camera 96, and requests the head office 10 to record the images as mid-processed images (S651). The mid-processed images are recorded into the image DB 61 (S661).

Due to the occurrence of disorder, the washing module 36 sends a message (namely, altered process notification) that asks the customer 20 whether the washing process should be continued and a message that requests the customer 20 to consent to continuation or suspension of the washing process, to the customer's terminal 14 (S652). The messages including the altered process notification and request of the consent are shown on the customer's terminal 14 (S670).

The customer's terminal 14 sends an instruction (namely, altered process indication), given by the customer 20, of continuing or suspending the washing process and a message (namely, the second consent information) indicating customer's consent or dissent to continuing the washing process to the washing module 36 (S671). Then, the washing module 36 (S653) receives the instruction and message and records them in the laundry record (S662) through the calculation for charging (SC651).

Receiving the message indicating customer's consent from the customer's terminal 14 enables the washing module 36 to continue or suspend the washing process in accordance with the altered process indication. Receiving the message indicating customer's dissent causes the washing module 36 to suspend the washing process regardless of content of the altered process indication (S654). A series of procedure mentioned above is the abnormal process.

When some disorder happens during the washing process, only receipt of both the first consent information and second consent information from the customer 20 allows the washing module 36 to report the completion of the abnormal process in order to surely execute the abnormal process.

In the above description, the washing module 36 notifies the customer's terminal 14 of occurrence of the disorder together with images. The way of notification is not limited to this. The washing module 36 may inform the customer's terminal 14 of the occurrence of disorder by just a message without images.

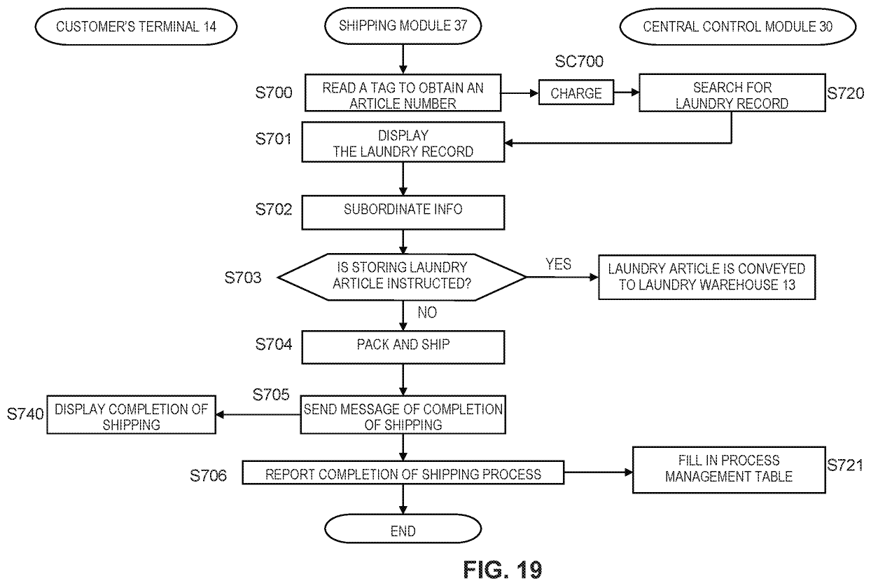

The flow of the shipping process is illustrated in FIG. 19. At the shipping module 37 in the laundry plant 12, an operator uses a tag reader 93 to read the tag attached to the laundry article to obtain an article number (S700). Then, the shipping module 37 requests the head office 10 to search for and browse the laundry record according to the article number.

At the head office 10 that has received the access request of browsing the laundry record, the charging unit 64 executes calculation of fee for the shipping module 37 (SC700). Thereafter, the laundry searching unit 55 searches the laundry DB 60 for the laundry record by the article number, and sends back the laundry record to the shipping module 37 (S720).

The laundry record sent back to the shipping module 37 is shown on the display 94 in the shipping module 37. An operator proceeds with shipping work on the laundry article by referring to the customer's contact information in the laundry record (S701).

An operator pays attention to subordinate information in the laundry record in order that he/she handles the laundry articles as the same pack of articles if they are labeled with main laundry articles or the secondary laundry articles. Until all of the articles with the subordinate information come to the shipping module 37, the shipping work on the laundry articles with the subordinate information is temporarily suspended (S702).

After all of the articles with the subordinate information are collected, an operator checks service information on the laundry record shown on the display 94 in order to find out whether service of storing the laundry article is instructed (S703).

The laundry article with storing instruction is conveyed to the laundry warehouse 13. However, a laundry article without subordinate information is checked whether it has a storing instruction just after S701 (S703).

The laundry article without any storing instruction is soon packed and shipped (S704). Needless to say, articles with subordinate information are collectively packed and shipped. When the shipping operation has completed, the shipping module 37 sends a message of the completion to the customer 20 (S705). The message is displayed on the customer's terminal 14 (S740).

Subsequently, the shipping module 37 reports completion of the shipping process to the head office 10 (S706). The completion report is treated at the control unit 51 in the central control module 30, which fills in “shipping” column in the process management table 80 with “completed” on the basis of the article number so as to record the completion notice in the table 80 (S721). The shipping module 40 in the laundry warehouse 13 works in the same way as the shipping module 37.

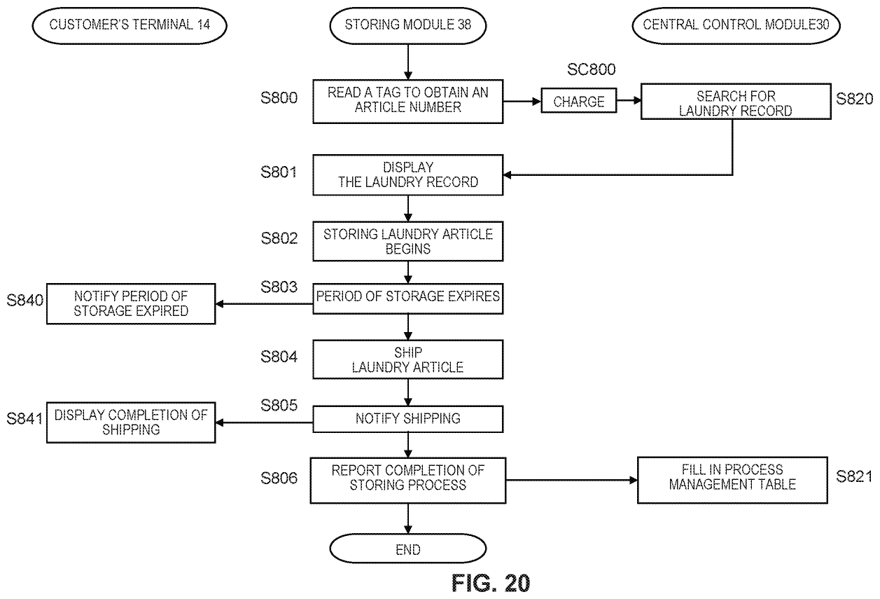

The flow of storing process is illustrated in FIG. 20. At the storing module 38 in the laundry warehouse 13, an operator uses a tag reader 93 to read the tag attached to the laundry article to obtain an article number (S800). Then, the storing module 38 requests the head office 10 to search for and browse the laundry record according to the article number.

At the head office 10 that has received the access request of browsing the laundry record, the charging unit 64 executes calculation of fee for the storing module 38 (SC800). Thereafter, the laundry searching unit 55 searches the laundry DB 60 for the laundry record by the article number, and sends back the laundry record to the storing module 38 (S820).

The laundry record sent back to the storing module 38 is shown on the display 94 in the storing module 38 (S801). An operator moves the article to predetermined position in the laundry warehouse 13, by referring to the article's attribute information in the laundry record, and then storing the laundry article begins (S802).

After the period of storage expires, the expiration is notified to the customer 20 (S803) and the notification is displayed on the customer's terminal 14 (S840). Thereafter, the laundry article is shipped (S804). Information related to the shipping is notified to the customer 20 (S805) and displayed on the customer's terminal 14 (S841).

Then, the storing module 38 reports completion of the storing process to the head office 10 (S806). The completion report is treated at the control unit 51 in the central control module 30, which fills in “storing” column in the process management table 80 with “completed” on the basis of the article number so as to record the notice of completion in the table 80 (S821).

4. Access to the Laundry DB 60 from Customer's Terminal

By using article number or information registered in the laundry DB 60 such as article's attribute information and article's state information, a customer's terminal 14 can access the laundry DB 60 managed by the head office 10. In this case, the access identifying unit 63 in the central control module 30 decides whether the access is bound for the laundry DB 60.

The appearance of the access destination is observed in the charging unit 64, and each time the access is observed, a customer's terminal 14, which is an access source, is charged. This enables the charging unit 64 to individually charge different customer's terminal for fee in the case that a plurality of terminals accesses the laundry DB 60.

One way of identifying an access source among a plurality of sources such as customer's terminals is use of network identifier (such as IP address) of an access source.

Furthermore, since both the laundry DB 60 and image DB 61 are connected with the article number, a customer is able to access the image DB 61 as well as laundry DB 60. As the laundry DB 60 includes image information, a customer's terminal can find images of the laundry article easily.

This structure enables a customer to access the laundry DB 60 and image DB61 for his/her laundry article and images by entering data such as an article number or article's attribute information into the customer's terminal 14. The customer is able to confirm progress of processing his/her laundry articles, to manage clothes in his/her possession and also to browse his/her usage history about laundry service via graphical images on the screen of customer's terminal 14.

Above-mentioned function browsing the laundry DB 60 is offered not only to customers that have already used this system but also to third parties that have intention of using this system. The third party registered with this system can search the laundry DB 60 for registered information to see the quality of laundry service.

FIG. 25 shows configuration of the central control module 30 that is a computer system including a processor 100, the memory 101, a storage 102, a network interface 103, an application specific IC (ASIC) 104, an input/output (I/O) interface 105 and an external device(s) 106. The central control module 30 can be a personal computer, a notebook computer, a server computer or multiple servers interconnected to each other with dedicated communication cables to get higher performance.

The processor 100 has one or more processing cores to execute the program stored in the memory 101. The memory 101 is configured with volatile memory such as random-access memory (RAM) and non-volatile memory such as read only memory (ROM). The memory 101 accommodates the program that performs functions provided by the central control module 30, wherein the functions include the control unit 51, the record number issuer 53, the article number issuer 54, the laundry searching unit 55, the laundry recording unit 56, the image searching unit 57, the image recording unit 58, and the control of the access identifying unit 63 and the charging unit 64.

The storage 102, which accommodates laundry DB 60 and image DB 61, may be a magnetic hard disk drive or a solid-state hard drive. The network interface 103 provides with communication to other processing modules 131 and the customer's terminal 14. Any type of physical communication line can be used as long as network interface 103 supports the internet protocol.

The ASIC 104 is semiconductor chip providing function of the access identifying unit 63 and the charging unit 64, as depicted in FIG. 23. The I/O interface 105 provides connection to the external device(s) 106, such as a keyboard, a display, and/or some other suitable external devices. The processor 100, the memory 101, the storage 102, the network interface 103, the ASIC 104 and the I/O interface 105 are interconnected through a computer bus 107 to exchange program and data.

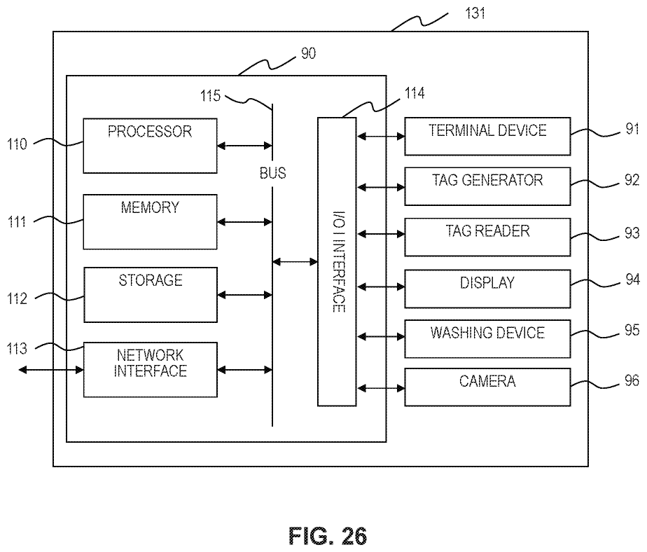

FIG. 26 shows configuration of the processing module 131 (namely, the reception module 31, the recording modules 32 and 39, the measuring module 35, the washing module 36, the shipping module 37 and 40, the storing module 38, the counselling module 33 and the payment module 34).

The module controller 90 that is a computer system including a processor 110, a memory 111, a storage 112, a network interface 113 and an I/O interface 114. The module controller 90 can be a personal computer, a notebook computer or a server computer. Processor 110 has one or more processing cores to execute the program stored in the memory 111, which is configured with volatile memory such as RAM and non-volatile memory such as ROM. The memory 111 accommodates the program that performs functions provided by the processing module 131.

The storage 112 may be a magnetic hard disk drive or a solid-state hard drive. The network interface 113 provides with communication to other processing module 131 and the customer's terminal 14. Any type of physical communication line can be used as long as the network interface 113 supports the internet protocol. The I/O interface 114 can provides connection to the terminal device 91, the tag generator 92, the tag reader 93, the display 94, the washing device 95 and the camera 96. However, I/O devices connected to the/O interface 114 differ for each processing module as shown in FIG. 6.

The processor 110, the memory 111, the storage 112, the network interface 113 and the I/O interface 114 are interconnected through a computer bus 115 to exchange program and data.

### Second Embodiment

In the first embodiment, charging is for only an access to the laundry records. But the way of charging is not limited to this. Access to the image DB 61 may be the object for charging. This is because the image information as well as the laundry record is important source of information in the laundry charging system.

In other words, the charging unit 64 executes charging by each processing module when each one requests the head office 10 to browse or to record images (such as pre-processed, post-processed and mid-processed images) into the image DB 61.

As shown by FIG. 9 in the first embodiment, a laundry record is accessible by not only an article number but by a record number. Moreover, images relevant to a laundry article is also searchable by the article number like FIG. 10. However, the laundry record and the images are not integrated.

In the second embodiment, images are incorporated to a laundry record. Each processing module can search the laundry record for information and images relevant to a laundry article with a single operation using an article number. In this case, the charging unit 64 also executes charging by each processing module when each module requests to browse and to record the images.

### Third Embodiment

In the first embodiment, the recording process is executed at the laundry plant 12. But the place is not limited to the laundry plant 12. The recording process may be executed at the laundry shop 11.

Furthermore, in the first embodiment, the reception process is executed in the laundry shop 11. The recording process, measuring process, washing process and shipping process are done in the laundry plant 12. The recording process, storing process and shipping process are done in the laundry warehouse 13, and the counseling process and payment process are done in the head office 10. Charge of each process is not limited to this. Different process may be done at the different place as long as the system continuously provides customers with the laundry service.

Moreover, these processes are executed at a place other than the head office 10, laundry shop 11, laundry plant 12 or laundry warehouse 13 (such as customer service or regional center).

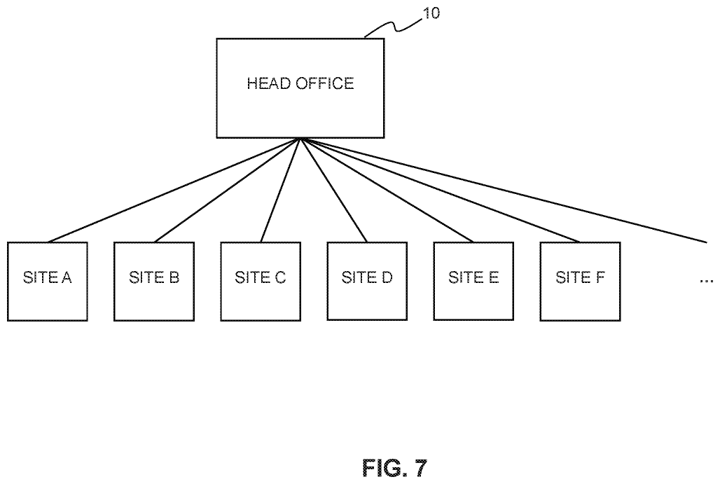

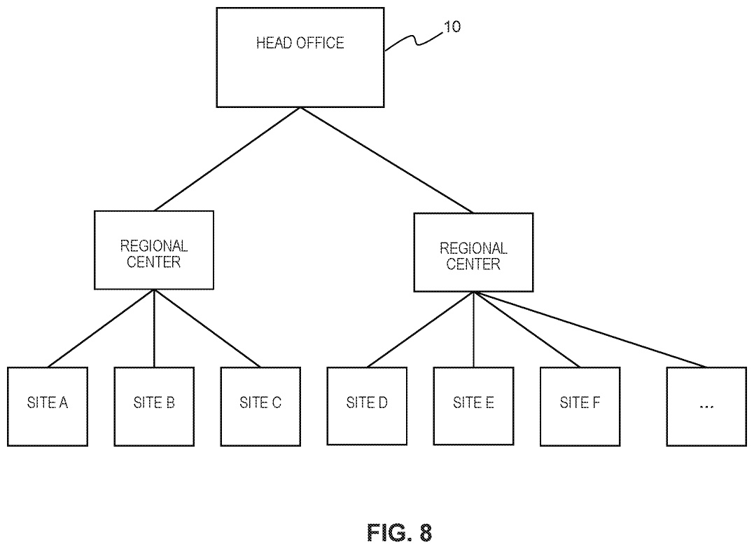

The first embodiment has a laundry shop 11, a laundry plant 12 and a laundry warehouse 13. However, the present invention is not limited to this, and a plurality of shops, plants and warehouses may be provided. In this case, each site (including the laundry shop 11, laundry plant 12, and laundry warehouse 13) may be directly connected to the head office 10, which is illustrated by FIG. 7. As another example is shown by FIG. 8, each site may be hierarchically connected to the head office 10 via regional center.

In the case of FIG. 8, although all sites communicate with the head office 10 via regional centers, all sites can directly access the laundry DB 60 and image DB 61 in the head office 10. The access identifying unit 63 can identify an access to the laundry records and the charging unit 64 can charge the access source for fee. FIG. 8 shows the structure having single stage of intermediate layer. Also, another example of structure may have a plurality of intermediate layers.

By above-mentioned structure, the franchiser, which administers the head office 10, is able to charge the franchisees, which operate sites such as the laundry shop 11, laundry plant 12 or laundry warehouse 13, for fee in proportional to the number of franchisee's accesses bound for the laundry records. As a result, it is possible to provide a charging method different from the conventional one such as charging a fixed rated fee of sales or a fixed amount of fee.

Here, the access to the laundry records includes not only the access to the laundry DB 60 on the basis of the article number but also the request to generate new article number. This is because request of issuing new article number causes new laundry record to be later added in the laundry DB 60, which virtually entails the access to the laundry DB 60.

### Fourth Embodiment

In the first embodiment, the access identifying unit 63 identifies an access source and the charging unit 64 charges each access source for the same fee.

Here, the charging unit 64 charges different access source or different access type for different fee. Specifically, the charging rate changes among a request of inquiry to the laundry record, a request of recording in the laundry record and a request of issuing the article number. For example, the request of issuing the article number has lower charging rate than the request of inquiry to the laundry record or the request of recording in the laundry record. This aims to encourage registration of new laundry article in the laundry records.

It is also possible to change the charging rate based on time information such as date or season. Furthermore, it is possible to change it according to the attribute of access source, which means that the charging rate may change by site (such as the laundry shop 11, laundry plant 12, and laundry warehouse 13), by region, or between a site and a customer's terminal. If charging fee for customer's terminal is low or free, it is expected that more customers browse the laundry records.

In the FIG. 8, it is also thinkable to change the charging rate between a regional center and a site. While the charging rate is freely changeable like this, how the charging rate is set depends on the franchisor's management policy.

### Fifth Embodiment

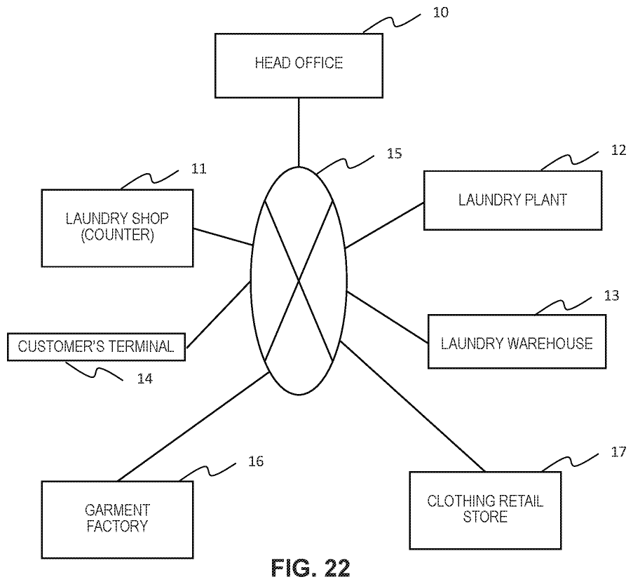

In the above-described embodiment, a tag is attached to a laundry article taken to a shop or the like, and management using a laundry record is started. Here, the head office 10 and garment factory 16 are further connected to network, and a tag is attached to an article of clothing manufactured and shipped at the garment factory 16, so that the management of clothing using laundry records is started from the manufacturing stage (FIG. 22). The garment factory 16 also includes small sewing site.

Here, the garment factory 16 can not only attach the tag to the manufactured clothes, but also write article's attributes information such as item, brand, shape, materials, colors and type to the attached tags at the stage of manufacturing the clothes. To realize this, the garment factory 16 has functions equivalent to the reception module 31 in the laundry shop 11 and recording module 32 in the laundry plant 12 in the first embodiment, so that it is possible to record and connect article's attribute information of manufactured clothing to the laundry record.

At this time, since a request for issuing an article number, a request for recording article's attribute information in the laundry record based on the article number, and a request for browsing the laundry record are made from the garment factory 16 to the central control module 30 in the head office 10, the charging unit 64 in the head office 10 performs calculation of charging for these requests.

Furthermore, if a clothing retail store 17 as well as the garment factory 16 is connected to network, it is possible to integrate the clothing retail store 17 into the system (FIG. 22). In this case, like the garment factory 16, the retail store 17 can associate information such as item, brand, shape, materials, colors and type with the attached tag, instead of simply attaching the tag to the clothes for sale.

As the laundry charging system of the present disclosure includes connection to the garment factory and clothing retail store, it is possible for the laundry charging system to share information on clothing among different industries and to provide companies with useful and efficient information.

The laundry records in the present disclosure is the most important source of information. The present disclosure is a method that charges a user in proportional to the frequency of use of this resource and is an alternative to a conventional charging method such as commission on sales. The method can fairly charge users that get access to the important and specific information, so that the method is useful for charging fees in various information system.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Thus, as used herein, the singular forms “a,” “an” and “the” are intended to include the plural forms as well, unless the context clearly indicates otherwise. Unless otherwise defined, all terms (including technical and scientific terms) used herein have the same meaning as commonly understood by one of ordinary skill in the art to which illustrative embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

While only selected embodiments have been chosen to illustrate the present invention, it will be apparent to those skilled in the art from this disclosure that various changes and modifications can be made herein without departing from the scope of the invention as defined in the appended claims. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A laundry charging system for managing a laundry article and doing laundry based on an article number, the article number generated at a head office is contained in a tag, the tag is attached to the laundry article, the head office is connected to a plurality of sites via network, the laundry charging system comprising:
an article number issuer in the head office configured to generate the article number;
a database in the head office configured to store a laundry record that includes information related to the laundry article corresponding to the article number;
an access identifying unit in the head office configured to evaluate a type of access to the head office from the site; and
a charging unit in the head office, wherein, when the access identifying unit identifies an access to the head office from the site that requests to the article number issuer for issuing the article number, the charging unit charges the site.

2. A laundry charging system for managing a laundry article and doing laundry based on an article number, the article number generated at a head office is contained in a tag, the tag is attached to the laundry article, the head office is connected to a plurality of sites via network, the laundry charging system comprising:
an article number issuer in the head office configured to generate the article number;
a database in the head office configured to store a laundry record that includes information related to the laundry article corresponding to the article number;
an access identifying unit in the head office configured to evaluate a type of access to the head office from the site; and
a charging unit in the head office, wherein, when the access identifying unit identifies an access to the head office from the site that is the access bound for the laundry record based on the article number, the charging unit charges the site.

3. The laundry charging system according to claim 1, further comprising:
a tag reader in the site configured to read the tag, wherein the tag reader obtains the article number contained in the tag attached to the laundry article.

4. The laundry charging system according to claim 2, further comprising:
a tag reader in the site configured to read the tag, wherein the tag reader obtains the article number contained in the tag attached to the laundry article.

5. The laundry charging system according to claim 1, wherein
in the case that the tag reader fails to obtain the article number from the tag, the site requests the head office to generate a new article number.

6. The laundry charging system according to claim 2, wherein
in the case that the tag reader fails to obtain the article number from the tag, the site requests the head office to generate a new article number.

7. The laundry charging system according to claim 1, further comprising:
a module controller in the site configured to
send the laundry record, which is sent from the head office, to a customer's terminal according to customer's contact information, wherein the laundry record includes the information,
send article's laundry information and article's risk information, both of which are sent from the head office, to the customer's terminal according to the customer's contact information, and
receive a first consent information from the customer's terminal, wherein the first consent information indicates that the customer consents to the updated laundry record and the article's laundry information;
a process decision table in the head office configured to decide the article's laundry information related to the laundry article based on the laundry record; and
a risk decision table in the head office configured to decide the article's risk information related to the laundry article based on the laundry record.

8. The laundry charging system according to claim 2, further comprising:
a module controller in the site configured to
send the laundry record, which is sent from the head office, to a customer's terminal according to customer's contact information, wherein the laundry record includes the information,
send article's laundry information and article's risk information, both of which are sent from the head office, to the customer's terminal according to the customer's contact information, and
receive a first consent information from the customer's terminal, wherein the first consent information indicates that the customer consents to the updated laundry record and the article's laundry information;
a process decision table in the head office configured to decide the article's laundry information related to the laundry article based on the laundry record; and
a risk decision table in the head office configured to decide the article's risk information related to the laundry article based on the laundry record.

9. The laundry charging system according to claim 7, further comprising:
the module controller configured to
send a message to the customer's terminal according to the customer's contact information, wherein the message indicates a disorder is detected during washing process, and
receive second consent information from the customer's terminal, wherein the second consent information indicates customer's consent or dissent to continuing the washing process when the customer's terminal receives the message;
wherein, in the case that the module controller receives the first and second consent information from the customer's terminal, the module controller reports completion of the washing process to the head office after finishing the predetermined process.

10. The laundry charging system according to claim 8, further comprising:
the module controller configured to
send a message to the customer's terminal according to the customer's contact information, wherein the message indicates a disorder is detected during washing process, and
receive second consent information from the customer's terminal, wherein the second consent information indicates customer's consent or dissent to continuing the washing process when the customer's terminal receives the message;
wherein, in the case that the module controller receives the first and second consent information from the customer's terminal, the module controller reports completion of the washing process to the head office after finishing the predetermined process.

11. The laundry charging system according to claim 1, wherein
the laundry record includes images before and after the washing process, the customer's terminal has a display for displaying the images obtained through the head office based on the article number.

12. The laundry charging system according to claim 2, wherein
the laundry record includes images before and after the washing process, the customer's terminal has a display for displaying the images obtained through the head office based on the article number.

13. The laundry charging system according to claim 11, wherein
the images further include images recorded when the disorder is detected during the washing process.

14. The laundry charging system according to claim 12, wherein
the images further include images recorded when the disorder is detected during the washing process.

15. A laundry charging system comprising:
a network connecting a head office and at least one site providing laundry service;
an access identifying unit configured to
extract an access source identifier and an access destination identifier from an access signal that is a flow of an access coming from the site to the head office via the network,
store a predetermined first identifier,
compare the access destination identifier and the first identifier, and output the access source identifier if the access destination identifier and the first identifier are the same value; and
a charging unit configured to
store a predetermined second identifier,
compare the outputted access source identifier and the second identifier,
count number of times that the outputted access source identifier and the second identifier are the same value, and
calculate fee to be charged to the site based on the number of times and a predetermined unit fee.
